(19) United States
(12) Patent Application Publication
(10) Pub. No.: US 2014/0323077 A1
(43) Pub. Date: Oct. 30, 2014

(54) Solutions to Address "eNB Partial Failure" for a Public Warning System

(71) Applicant: NOKIA SIEMENS NETWORKS OY, Espoo (FI)

(72) Inventors: Devaki Chandramouli, Plano, TX (US); Nagaraja Rao, Boco Raton, FL (US)

(73) Assignee: Nokia Siemens Networks Oy, Espoo (FI)

(21) Appl. No.: 13/870,421

(22) Filed: Apr. 25, 2013

(51) Int. Cl. G08B 27/00; H04W 4/22

(52) U.S. Cl. CPC G08B 27/006; H04W 4/22
USPC 455/404.1

(57) ABSTRACT

A method includes detecting cell(s) for a base station have entered an operationally active state and determining whether the cell(s) correspond to tracking area(s) having an outstanding warning message for a public warning system (PWS). The method includes sending, in response to the detecting and to a determination the cell(s) correspond to the tracking area(s) having the outstanding warning message for the PWS, a message to the base station indicating the warning message should be sent at least to the cell(s). Another method includes storing at abase station alert broadcast information corresponding to a warning message for a PWS, detecting that one of a number of cells for the base station has entered an operationally active state, and sending the warning message to the user equipment for at least the cell that has entered the operationally active state. Apparatus and program products are also disclosed.

### TECHNICAL FIELD

This invention relates generally to wireless communications and, more specifically, relates to public warning systems in wireless transmissions.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below at the end of the specification but prior to the claims.

EPS is the Evolved Packet System, and is the successor of GPRS (General Packet Radio System). The EPS provides a new radio interface and new packet core network functions for broadband wireless data access. Such EPS core network functions are the Mobility Management Entity (MME), Packet Data Network Gateway (PDN-GW, P-GW) and Serving Gateway (S-GW).

To deliver public warning messages, e.g., from national authorities to users in a certain area, a PWS (Public Warning System) architecture has been defined. The PWS architecture allows alerts to be broadcast to multiple cells in an eNB. The eNB therefore can alert UEs in the coverage area of the eNB.

Although the PWS architecture as defined is useful for alert dissemination to eNBs and to UEs, operations using the PWS architecture can be improved.

### SUMMARY

This section contains examples of possible implementations and is not meant to be limiting.

In an exemplary embodiment. a method includes detecting one or more of a plurality of cells for a base station have entered an operationally active state and determining, responsive to the detecting, whether the one or more cells correspond to one or more tracking areas having an outstanding warning message for a public warning system. The method includes sending, in response to the detecting and to a determination the one or more cells correspond to the one or more tracking areas having the outstanding warning message for the public warning system, a message to the base station indicating the warning message should be sent at least to the one or more cells.

An additional exemplary embodiment includes a computer program, comprising code for detecting one or more of a plurality of cells for a base station have entered an operationally active state; code for determining, responsive to the detecting, whether the one or more cells correspond to one or more tracking areas having an outstanding warning message for a public warning system; and code for sending, in response to the detecting and to a determination the one or more cells correspond to the one or more tracking areas having the outstanding warning message for the public warning system, a message to the base station indicating the warning message should be sent at least to the one or more cells, when the computer program is run on a processor. The computer program according to this paragraph. wherein the computer program is a computer program product comprising a computer-readable medium bearing computer program code embodied therein for use with a computer.

An exemplary apparatus includes means for detecting one or more of a plurality of cells for a base station have entered an operationally active state; means for determining, responsive to the detecting, whether the one or more cells correspond to one or more tracking areas having an outstanding warning message for a public warning system; and means for sending, in response to the detecting and to a determination the one or more cells correspond to the one or more tracking areas having the outstanding warning message for the public warning system, a message to the base station indicating the warning message should be sent at least to the one or more cells.

An exemplary apparatus includes one or more processors and one or more memories including computer program code. The one or more memories and the computer program code are configured to, with the one or more processors, cause the apparatus to perform at least the following: detecting one or more of a plurality of cells for a base station have entered an operationally active state; determining, responsive to the detecting. whether the one or more cells correspond to one or more tracking areas having an outstanding warning message for a public warning system; and sending, in response to the detecting and to a determination the one or more cells correspond to the one or more tracking areas having the outstanding warning message for the public warning system, a message to the base station indicating the warning message should be sent at least to the one or more cells.

An exemplary computer program product includes a computer-readable storage medium bearing computer program code embodied therein for use with a computer. The computer program code includes: code for detecting one or more of a plurality of cells for a base station have entered an operationally active state; code for determining, responsive to the detecting, whether the one or more cells correspond to one or more tracking areas having an outstanding warning message for a public warning system: and code for sending, in response to the detecting and to a determination the one or more cells correspond to the one or more tracking areas having the outstanding warning message for the public warning system, a message to the base station indicating the warning message should be sent at least to the one or more cells.

A further exemplary embodiment is a method. The method includes storing at a base station alert broadcast information corresponding to a warning message for a public warning system and detecting that one of a plurality of cells for the base station has entered an operationally active state. The method also includes sending, responsive to the detecting, the warning message to the user equipment for at least the cell that has entered the operationally active state. In this embodiment, for instance, the eNB can send a Restart message to the MME with a flag indicating that an auto-restart occurred at the eNB. If this flag is received, the MME can simply forward the Restart message to the CBC. The CBC does not act upon the Restart message. Instead, the Restart message just is used to inform the CBC that the broadcast has been automatically started in a recovered cell.

An additional exemplary embodiment includes a computer program, comprising code for storing at abuse station alert broadcast information corresponding to a warning message for a public warning system; code for detecting that one of a plurality of cells for the base station has entered an operationally active state; and code for sending, responsive to the detecting, the warning message to the user equipment for at least the cell that has entered the operationally active state, when the computer program is run on a processor. The computer program according to this paragraph, wherein the computer program is a computer program product comprising a computer-readable medium bearing computer program code embodied therein for use with a computer.

Another exemplary embodiment is an apparatus comprising: means for storing at abuse station alert broadcast information corresponding to a warning message for a public warning system; means for detecting that one of a plurality of cells for the base station has entered an operationally active state; and means for sending, responsive to the detecting, the warning message to the user equipment for at least the cell that has entered the operationally active state.

An exemplary apparatus includes one or more processors and one or more memories including computer program code. The one or more memories and the computer program code are configured to, with the one or more processors, cause the apparatus to perform at least the following: storing at a base station alert broadcast information corresponding to a warning message for a public warning system; detecting that one of a plurality of cells for the base station has entered an operationally active state; and sending, responsive to the detecting, the warning message to the user equipment for at least the cell that has entered the operationally active state.

An exemplary computer program product includes a computer-readable storage medium bearing computer program code embodied therein for use with a computer. The computer program code includes: code for storing at a base station alert broadcast information corresponding to a warning message for a public warning system; code for detecting that one of a plurality of cells for the base station has entered an operationally active state; and code for sending, responsive to the detecting, the warning message to the user equipment for at least the cell that has entered the operationally active state.

### BRIEF DESCRIPTION OF THE DRAWINGS

In the attached Drawing Figures:

FIG. 1 is a block diagram of an example PWS architecture;

FIG. 2 illustrates an exemplary system in which the exemplary embodiments may be practiced;

FIG. 3 is an example of how a system might be configured in order to support a PWS architecture;

FIG. 4, including FIGS. 4A and 4B, is a signaling and flow diagram illustrating a partial failure scenario of a PWS for LTE signaling;

FIG. 5, including FIGS. 5A and 5B, is a signaling and flow diagram illustrating a partial failure scenario of a PWS re-using concepts defined for 2G/3G;

FIG. 6, including FIGS. 6A and 6B, is a signaling and flow diagram illustrating a partial failure scenario in an exemplary embodiment herein;

FIG. 7, including FIGS. 7A, 7B, 7C, and 7D, is a signaling and flow diagram illustrating a partial failure scenario of re-using 2G/3G PWS concepts;

FIG. 8, including FIGS. 8A and 8B, is a signaling and flow diagram illustrating a partial failure scenario in an exemplary embodiment herein;

FIG. 9, including FIGS. 9A, 9B, 9C, and 9D, is a signaling and flow diagram illustrating total and partial failure cases, illustrating a problem with 2G/3G importation into LTE;

FIG. 10, including FIGS. 10A, 10B, 10C, and 10D, is a signaling and flow diagram illustrating total and partial failure cases in an exemplary embodiment;

FIG. 11 is a block diagram of an exemplary logic flow diagram for addressing “eNB Partial Failure” for a public warning system, and a diagram that illustrates the operation of an exemplary method, a result of execution of computer program instructions embodied on a computer readable memory, and/or functions performed by logic implemented in hardware, in accordance with exemplary embodiments herein; and

FIG. 12 is a block diagram of an exemplary logic flow diagram for addressing “eNB Partial Failure” for a public warning system, and a diagram that illustrates the operation of an exemplary method, a result of execution of computer program instructions embodied on a computer readable memory, and/or functions performed by logic implemented in hardware, in accordance with exemplary embodiments herein.

### DETAILED DESCRIPTION OF THE DRAWINGS

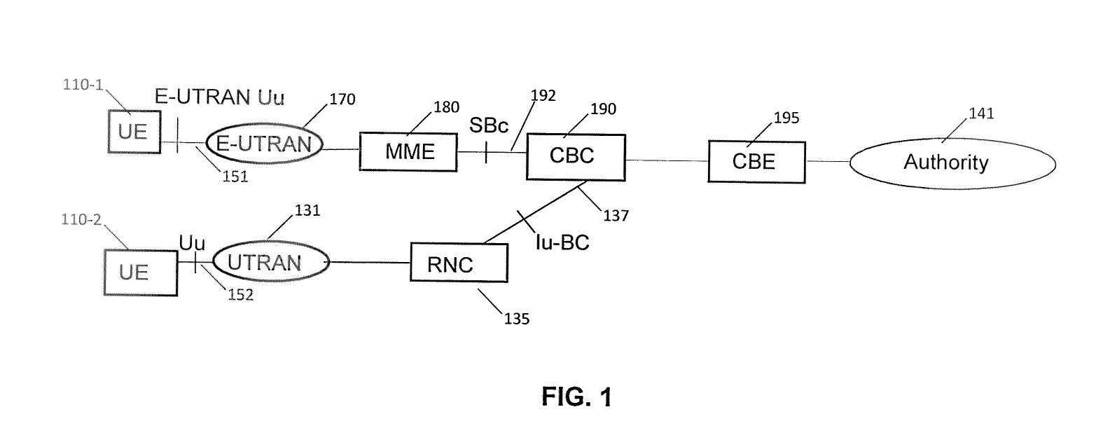

As stated above, to deliver public warning messages, e.g., from national authorities to users in a certain area, a PWS architecture has been defined. An example of the PWS architecture is shown in FIG. 1. In this example, the authority 141 communicates through the CBE 193 and the CBC 190 to a UTRAN system (via a link 137, which implements an Iu-BC interface) and an E-UTRAN system (via a link 192, which implements an SBc interface). The E-UTRAN system includes an MME 180, and an E-UTRAN node (i.e., an eNB 170). The eNB 170 communicates with a UE 110-1 over wireless link 151, which implements an E-UTRAN Uu interface. The UTRAN system includes an RNC (Radio Network Controller), and a UTRAN access node (i.e., a Node B 131). The Node B 131 communicates via a wireless link 152 that implements a Uu interface with UE 110-2.

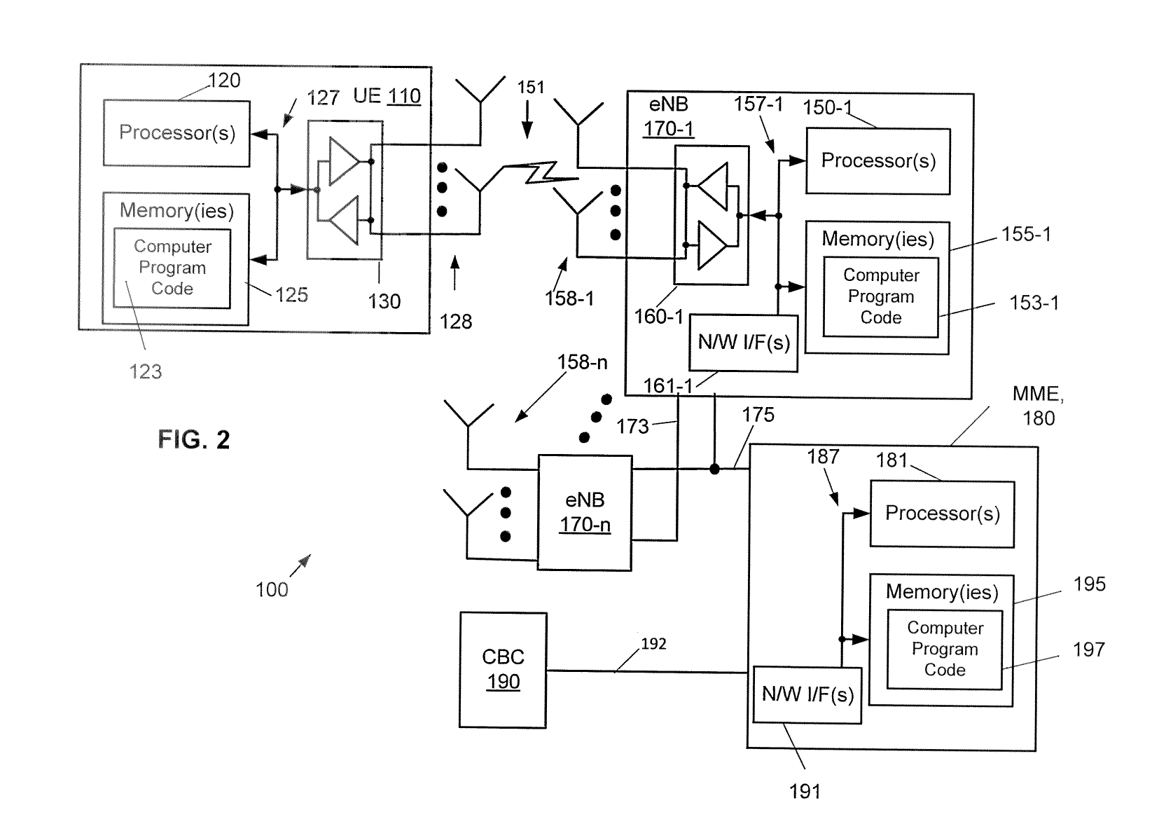

FIG. 2 illustrates an exemplary system in which the exemplary embodiments may be practiced. FIG. 2 concentrates on the E-UTRAN system, but the techniques herein are not limited to such a system. In FIG. 2, a user equipment (UE) 110 is in wireless communication with a wireless network 100. The user equipment 110 includes one or more processors 120, one or more memories 125, and one or more transceivers 130 interconnected through one or more buses 127. The one or more transceivers 130 are connected to one or more antennas 128. The one or more memories 125 include computer program code 123.

The wireless network 100 includes n eNodeBs (eNBs) 170-1 through 170-n and an MME 180, and the wireless network 100 is connected to a CBC 190 via link 192. The eNBs 170 are base stations providing wireless access to the wireless network 100. The internal elements of eNodeB 170-1 will be described herein, and it is assumed the other eNodeBs 170 are similar. The eNodeB 170-1 includes one or more processors (e.g., means for processing) 150-1, one or more memories (e.g., means for storing) 155-1, one or more network interfaces (N/W I/F(s)) (e.g., means for communicating) 161-1, and one or more transceivers, means for communicating) 160-1 interconnected through one or more buses 157-1. The one or more transceivers 160-1 are connected to one or more antennas 158-1. The one or more memories 155-1 include computer program code 153-1. In an exemplary embodiment, the one or more memories 155-1 and the computer program code 153-1 may be configured to, with the one or more processors 150-1, cause the eNodeB 170-1 to perform one or more of the operations as described herein. The one or more network interfaces 161-1 communicate over networks such as the networks 173, 175.

The MME 180 includes one or more processors (e.g., means for processing) 181, one or more memories (e.g., means for storing) 195, and one or more network interfaces (N/W I/F(s)) (e.g., means for communicating) 191 interconnected through one or more buses 187. The one or more memories 195 include computer program code 197. In an exemplary embodiment, the one or more memories 195 and the computer program code 197 may be configured to, with the one or more processors 180, cause the MME 180 to perform one or more of the operations as described herein. The one or more network interfaces 191 communicate over networks such as the networks 173, 175.

The eNodeBs 170 communicate using, e.g., network 173. The network 173 may be wired or wireless or both and may implement, e.g., an X2 interface. The MME 180 uses the network 175 to communicate with the eNodeBs 170. The network 175 may be wired or wireless or both and may implement, e.g., an S1 interface.

The computer readable memories 155 and 195 may be of any type suitable to the local technical environment and may be implemented using any suitable data storage technology, such as semiconductor based memory devices, flash memory, magnetic memory devices and systems, optical memory devices and systems, fixed memory and removable memory. The processors 150 and 181 may be of any type suitable to the local technical environment, and may include one or more of general purpose computers, special purpose computers, microprocessors, digital signal processors (DSPs) and processors based on a multi-core processor architecture, as non-limiting examples.

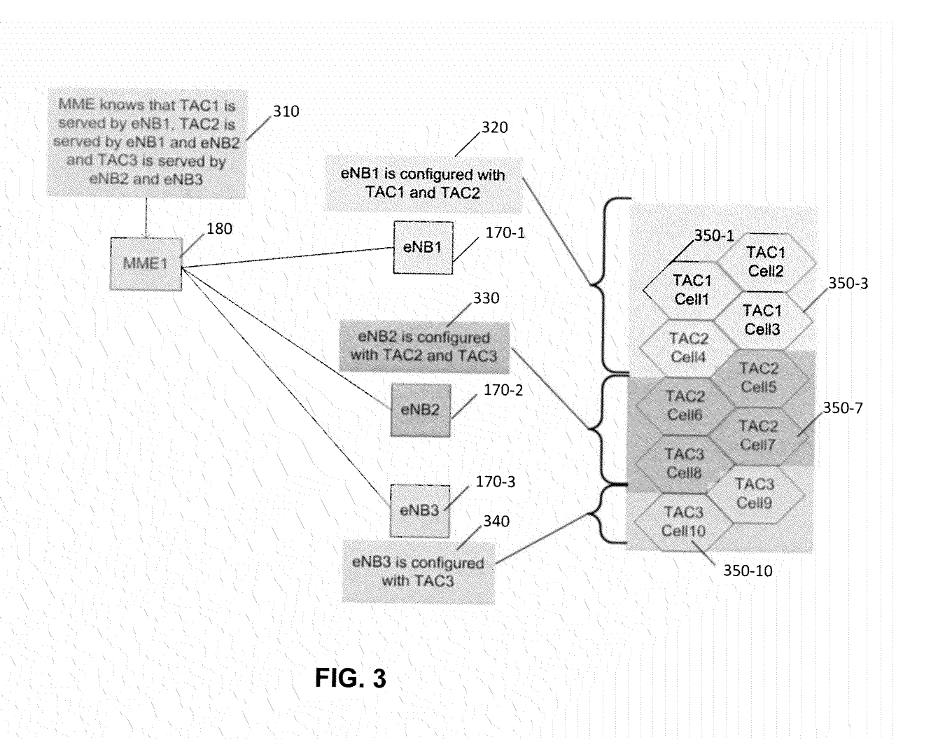

Before proceeding with description of problems with current PWS architecture, reference is made to FIG. 3 for an example of how a system 100 might be configured in order to support a PWS architecture. The cells 350 and the corresponding eNBs 170 are divided into groups of cells, using a TAC (Tracking Area Code). As indicated in 3GPP TS 23.003 V11.5.0 (2013 March) §19.4.2.3 (“Tracking Area Identity (TAI)”), a TAC is defined as a fixed length code (of 2 octets) identifying a Tracking Area within a PLMN. A PLMN is a network that is established and operated by an administration or by a recognized operating agency for the specific purpose of providing land mobile telecommunications services to the public. The MME 180 determines (block 310) that TAC1 is served by eNB1 170-1, that TAC2 is served by eNB1 170-1 and eNB2 170-2 and that TAC3 is served by eNB2 170-2 and eNB3 170-3. Put differently, eNB1 is configured (block 320) with TAC1 and TAC2; eNB2 is configured (block 330 with TAC2 and TAC3; and eNB3 is configured (block 340) with TAC3. TAC1 is assigned cells 1-3 (350-1 to 350-3); TAC2 is assigned cells 5-8 (350-5 to 350-8); and TAC3 is assigned cells 9 (350-9) and 10 (350-10).

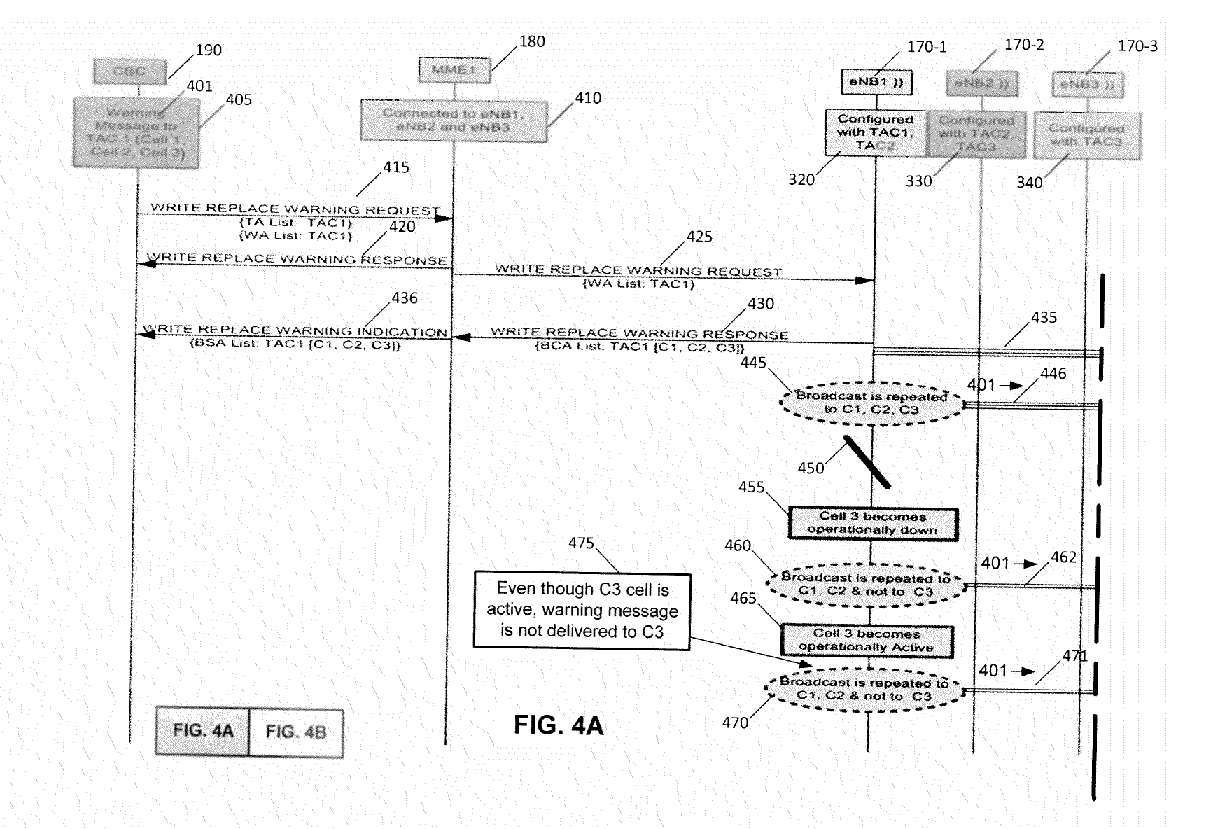

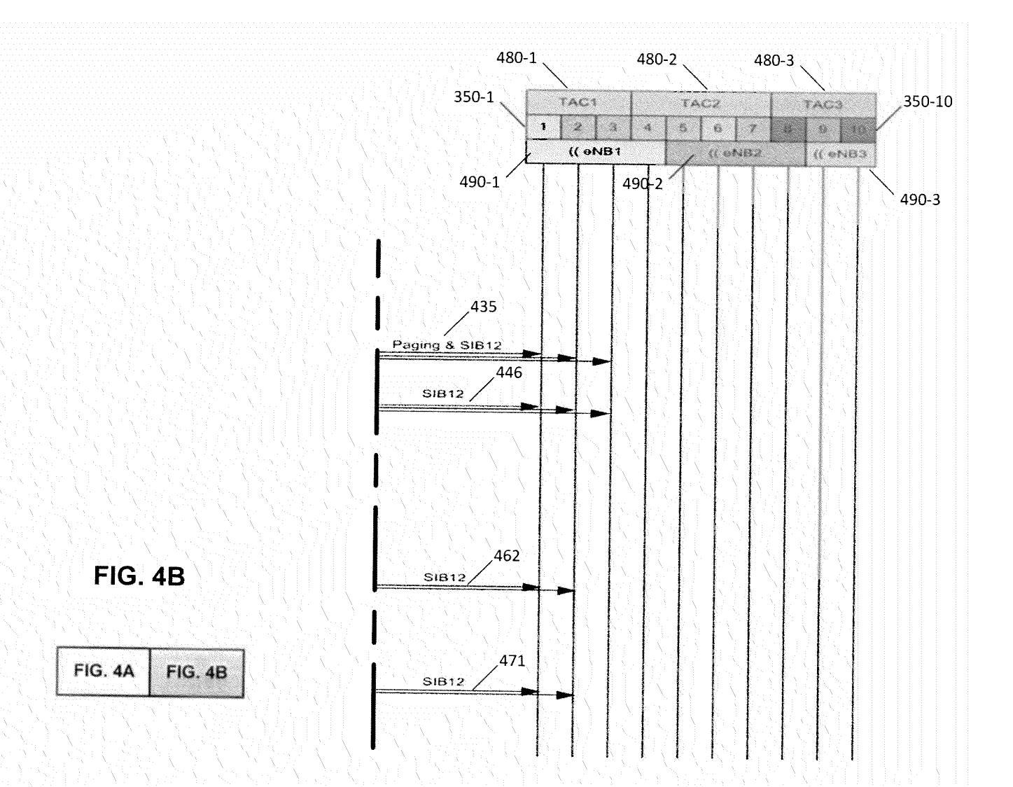

If an alert is to be broadcast to multiple cells in an eNB 170 and if the eNB 170 is partially down (that is, one or more of the total number of cells controlled by the eNB cannot broadcast) and if the eNB 170 recovers from that failure, i.e., the cell 350 recovers, the current system does not result in the alert broadcast to that recovered cell. The users in that area may never receive an emergency notification. This is a public safety concern and issue. This is explained in reference, e.g., to FIG. 4.

In FIG. 4, which includes FIGS. 4A and 4B, the CBC 190 is to send (block 405) a warning message 401 to TAC1 480-1, which includes cells 1-4 (350-1 to 350-4). The WA (Warning Area) includes TACs 1-3 and cells 1-10. The TAC2 480-2 includes cells 4-7 (350-4 to 350-7), and TAC3 480-3 includes cells 8-10 (350-8 to 350-10). Block 410 illustrates that the MME1 180 is connected to eNB1 170-1, eNB2 170-2, and eNB3 170-3. The CBC 190 sends message 415, a Write Replace Warning Request, which includes a TA list of TAC1 and a WA list of TAC1. to MME 180. The MME 180 responds to the CBC 190 with a Write Replace Warning Response message 420. The MME 180 in response to message 415 sends a Write Replace Warning Request message 425, with a WA list of TAC1 to eNB 1 170-1. The eNB1 responds with a Write Replace Warning Response message 430, with a Broadcast Completed Area list (BCA) of TAC1 and indications of cells C1, C2, and C3. The MME 180 sends a Write Replace Warning indication message 436 to the CBC 190, where the message 436 includes a Broadcast Scheduled Area list (BSA) including an indication of TAC1 and indications of cells C1, C2, and C3. The eNB 170-1 sends paging and SIB12 messages 435 to UE(s) in cells C1, C2, and C3. In reference 445, the eNB 170-1 repeats the broadcasting of warning message 401 to UEs 110 in the cells C1, C2, and C3 via SIB messages 446.

Reference 450 is used to indicate that a problem occurs with eNB 170-1. Specifically, cell 3 becomes operationally down (block 455). That is, a partial failure of eNB 170-1 occurs. In block 460, the eNB 170-1 repeats (via SIB 12 messages 462) the broadcasted warning message 401 to UEs 110 in the cells C1 and C2 but not to UEs in the cell C3. In block 465, cell 3 becomes operationally active again. Operationally down means that the cell is, e.g., out of service, while operationally active means, e.g., that the cell is in service. In reference 470, it is illustrated that the eNB 170-1 repeats broadcasting the warning message 401 to UEs in the cells C1 and C2 but not to UEs in cell C3 via SIB12 signaling 471. Block 475 illustrates a problem, which is that even though cell C2 is active, the warning broadcast messages are not delivered to cell C3.

For instance, if there is some emergency for which residents should be alerted, residents served by the cell C1 350-1 will not receive an alert when C1 is down. This is to be expected, as the cell is operationally down. However when the cell recovers, system design should allow warning messages to be broadcasted in C1 both for the sake of original residents in the cell and late entrants into the cell. This is a limitation with current solution in 3GPP specifications, as there is no auto-restart in the eNB nor is there an indication from other network elements to initiate the broadcast (e.g. to cell C3 in this case).

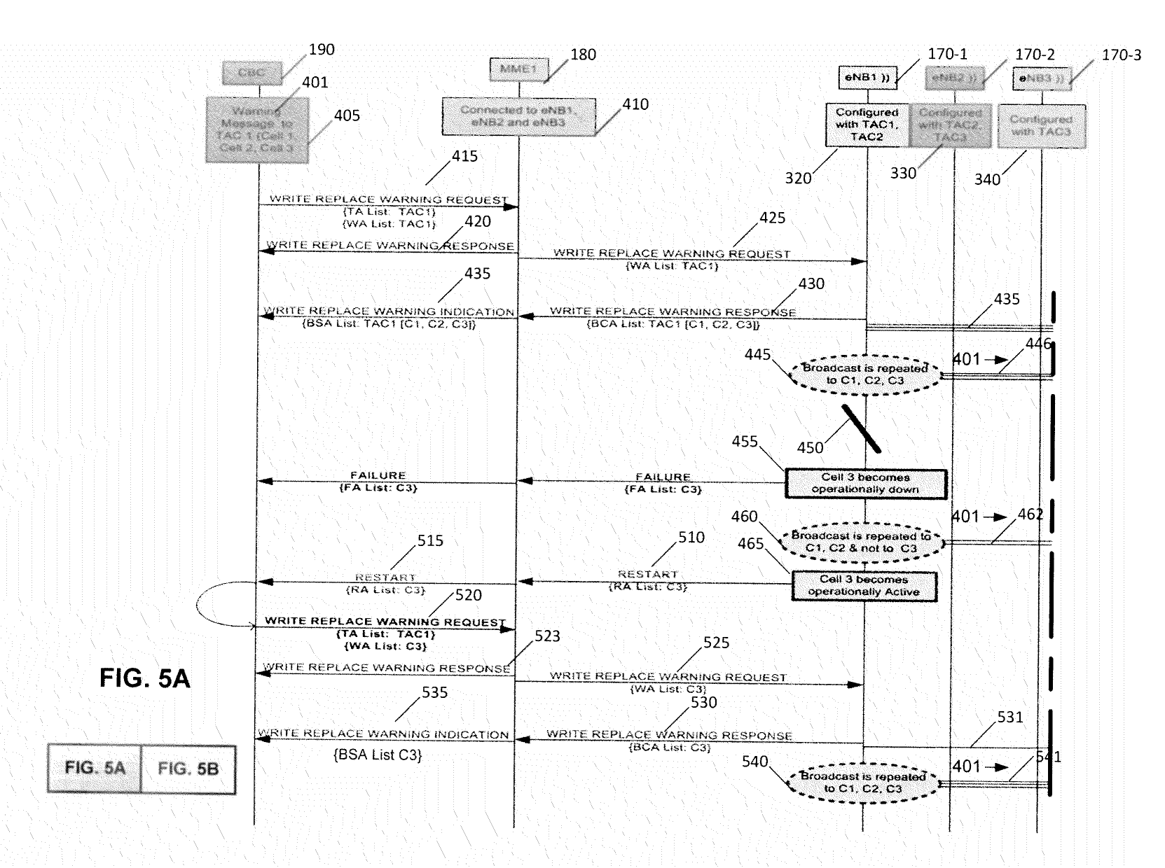

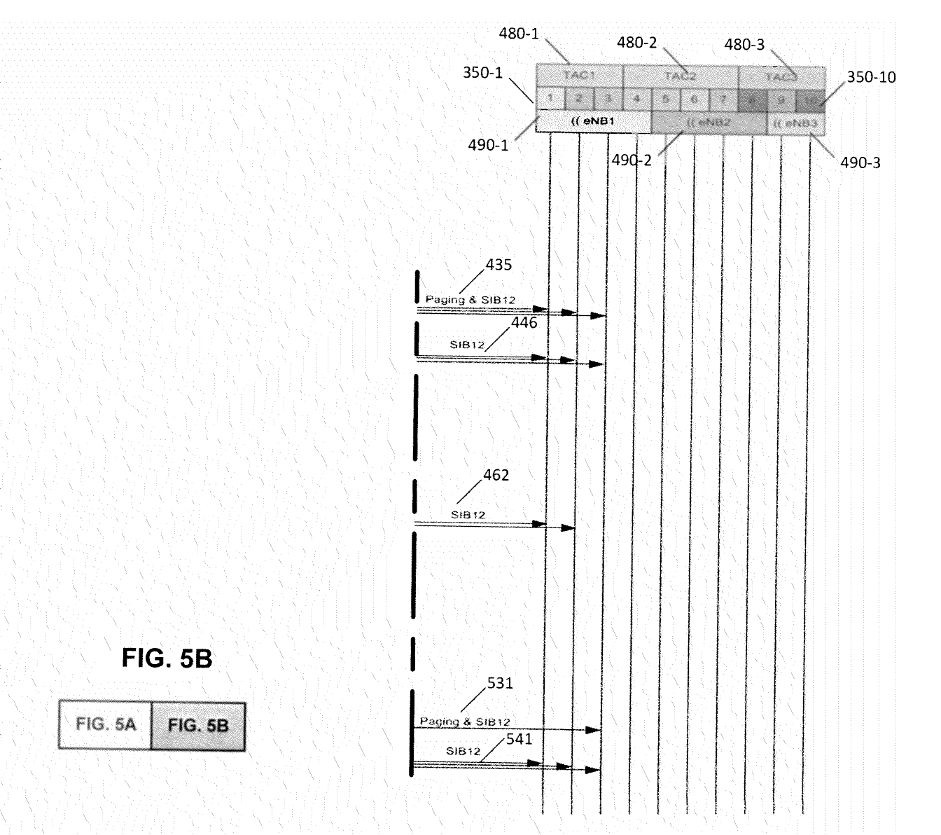

FIG. 5, including FIGS. 5A and 5B, also illustrates another limitation. FIG. 5 is a signaling and flow diagram illustrating a partial failure scenario of a PWS re-using concepts defined for 2G/3G. The start of the flow is the same as in FIG. 4, up until block 465, when Cell 3 (C3) becomes operationally active. The eNB1 170-1 sends a Restart message 510 including a Restart cell-list, recovery indication, of C3 to the MME 180. If the recovery indication is present, then the recovery indication indicates whether warning messages-related data are lost for the cells referenced in the cell-list and have to be re-loaded. If recovery indication is absent, then MME should interpret the absences as warning messages-related data are lost, Recovery indication can be included in Restart messages in general. This can apply to all figures herein having a Restart message. The MME 180 forwards the message 510 as message 515 to the CBC 190. The CBC 190 sends a Write Replace Warning Request message 520 with a TA list of TAC1 and a WA list of C3 to the MME 180. The MME 180 responds to the CBC 190 with a Write Replace Warning Response message 523. The MME 180 sends a Write Replace Warning Request message 525 with a WA list of C3 to the eNB1 170-1 (since the TAC1 is assigned to eNB1 170-1). The eNB1 170-1 responds to the MME 180 with a Write Replace Warning Response message 530 with a WA list of C3. The MME 180 sends a Write Replace Warning Indication message 535 to the CBC 190 with a BSA list of C3.

The eNB1 170-1, responsive to message 525, sends paging and SIB12 signaling 531 to UE(s) in cell C3 350-3 and repeats broadcasting the warning message 401 (via SIB12 signaling 541) to UE(s) in cells C1 350-1, C2 350-2, and C3 350-3 in operation 540.

The use of failure/restart scheme is shown in FIG. 5. The failure/restart scheme is a concept typically applied in 2G/3G systems. In this scheme, the MME 180 has no knowledge of eNB-to-cell configuration. The MME 180 knows about the eNBs 170 via the tracking area. A tracking area may include multiple eNBs. When a cell is recovered, if the eNB reports that recovery via a RESTART message and if the MME relays that message to the CBC and CBC issues a Write Replace Warning Request (message 520 in FIG. 5), the Write Replace Warning Request message will have the TACs. In the case of FIG. 5, that is TAC1 480-1. The Write Replace Warning Request message 525 can go to all the eNBs that cover that TA. This is unnecessary signaling where the Write Replace Warning Request message 525 should have gone to just one eNB 170 (e.g., or possibly to a single cell for that eNB).

The exemplary embodiments herein correct for these and additional problems. The exemplary embodiments include two main but non-limiting options to address eNB partial failure for PWS:

1. MME 180 initiates a Write Replace Warning Request message based on a restart indication from an eNB and notifies the CBC 190 with a Write Replace Warning Indication message.

2. An eNB 170 performs auto restart and notifies the CBC 190 with a restart message.

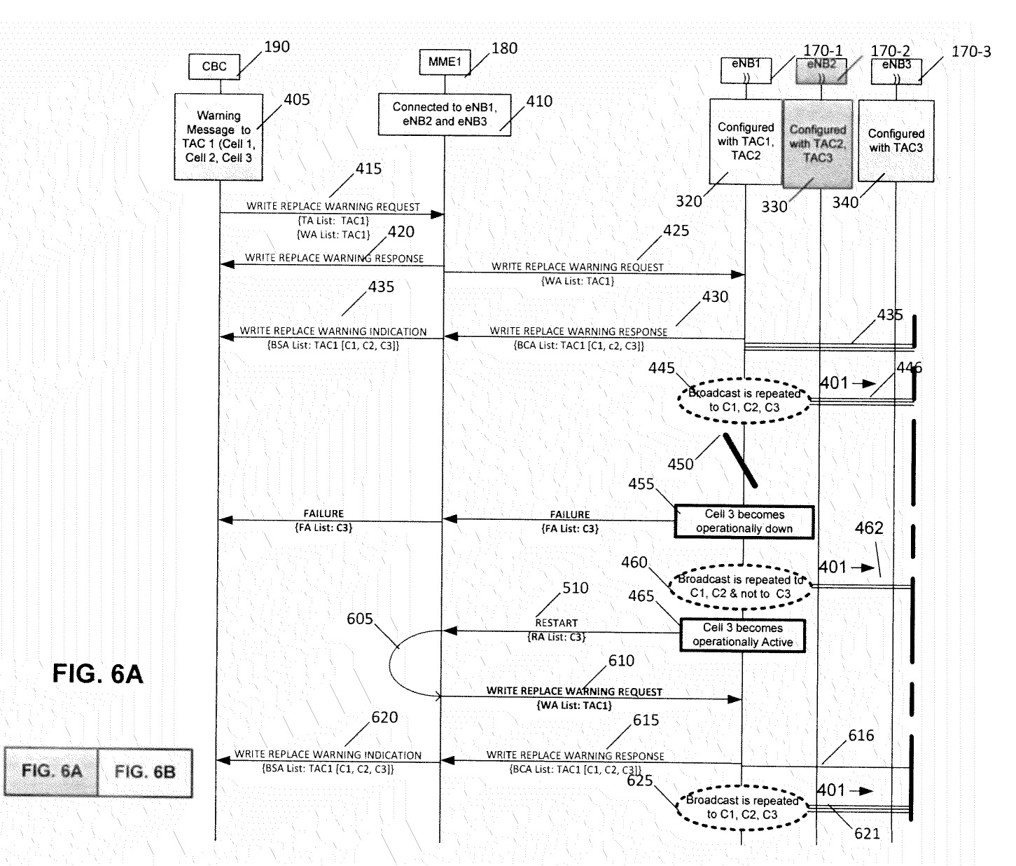

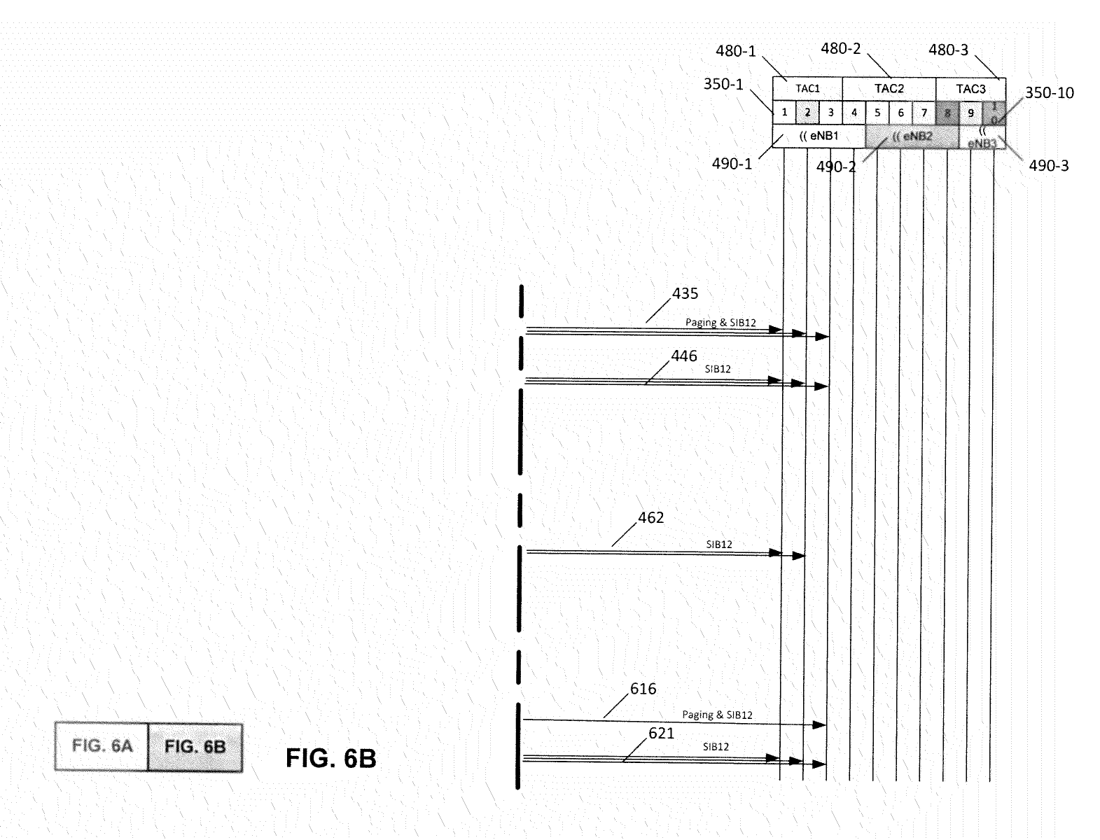

Concerning option 1, this solution proposes that an MME should use its internal logic and return a Write Replace Warning Request message with that recovered cell in the Warning Area list when the eNB receives Restart indication from the eNB upon recovery from partial failure, Only one eNB is notified in this. Reference is made to FIG. 6 for an example. FIG. 6, including FIGS. 6A and 6B, is a signaling and flow diagram illustrating a partial failure scenario in an exemplary embodiment herein. FIG. 6 corresponds to FIG. 5 at least until block 465, when cell C3 becomes operationally active and the eNB1 170-1 sends a restart message 510 toward the MME 180. Upon reception of the Restart message 510, the MME 180 does not forward the Restart message (as message 515 in FIG. 5) to the CBC 190. Instead, the MME 180 determines (operation 605) it is to send a Write Replace Warning Request message 610 (comprising the WA list of TAC1) to the eNB1 170-1. Responsive to the message 610, the eNB1 170-1 sends a Write Replace Warning Response message 615 to the MME 180 with a BCA list of TAC1 {C1, C2, C3}. The MME 180 sends a Write Replace Warning Indication message 620 to the CBC. The message 620 includes the BCA list of TAC1 {C1, C2, C3}.

The eNB1 170-1 also sends paging and SIB12 signaling 616 to UE(s) in cell C3 350-3. The eNB1 170-1 repeats (in operation 625) the broadcasted warning message 401 to UEs 110 in cells C1, C2, and C3 via SIB12 signaling 621. FIG. 6 therefore has the benefit of addressing the public safety issue shown in FIG. 4 (i.e. missed broadcast upon recovery from partial failure) and the benefit of less signaling relative to the version shown in FIG. 5.

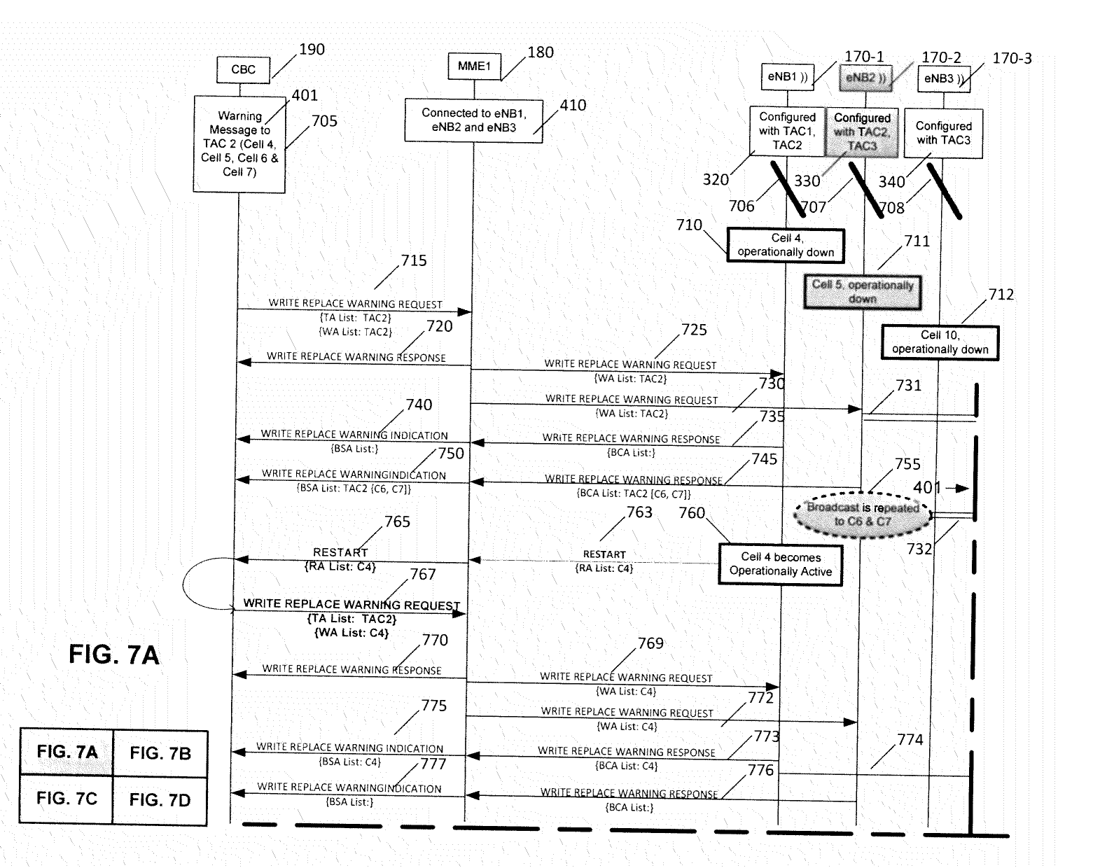

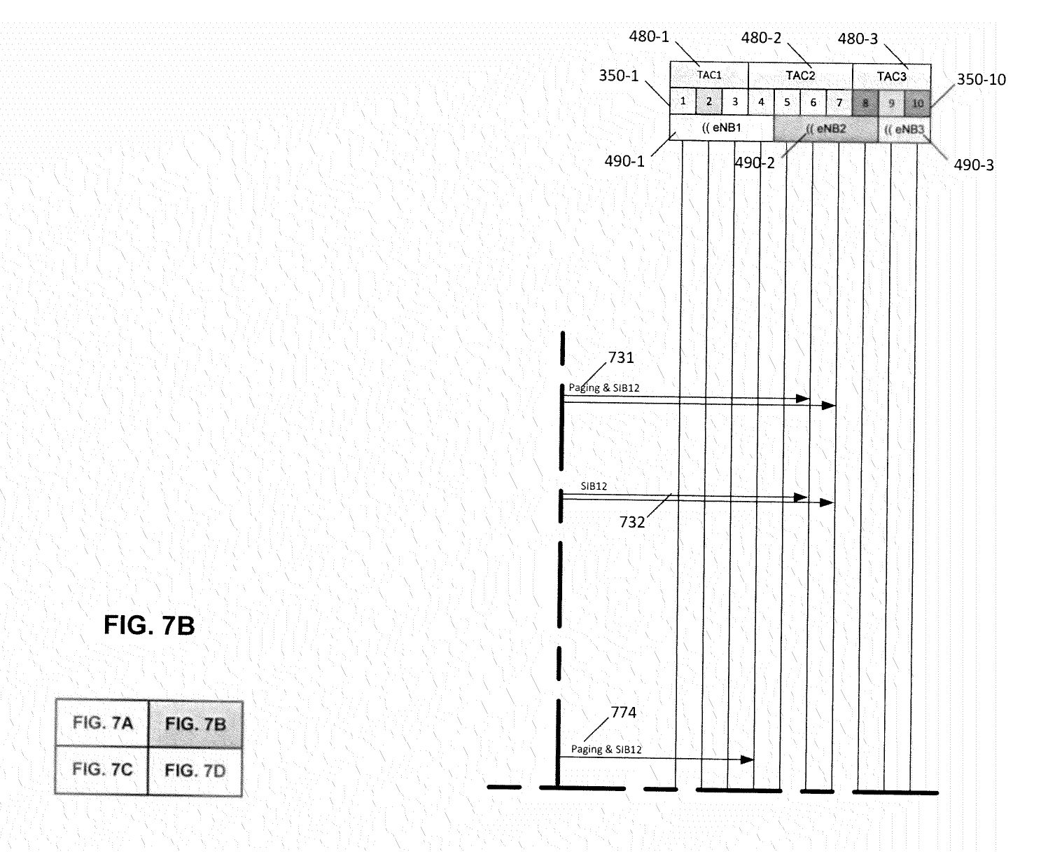

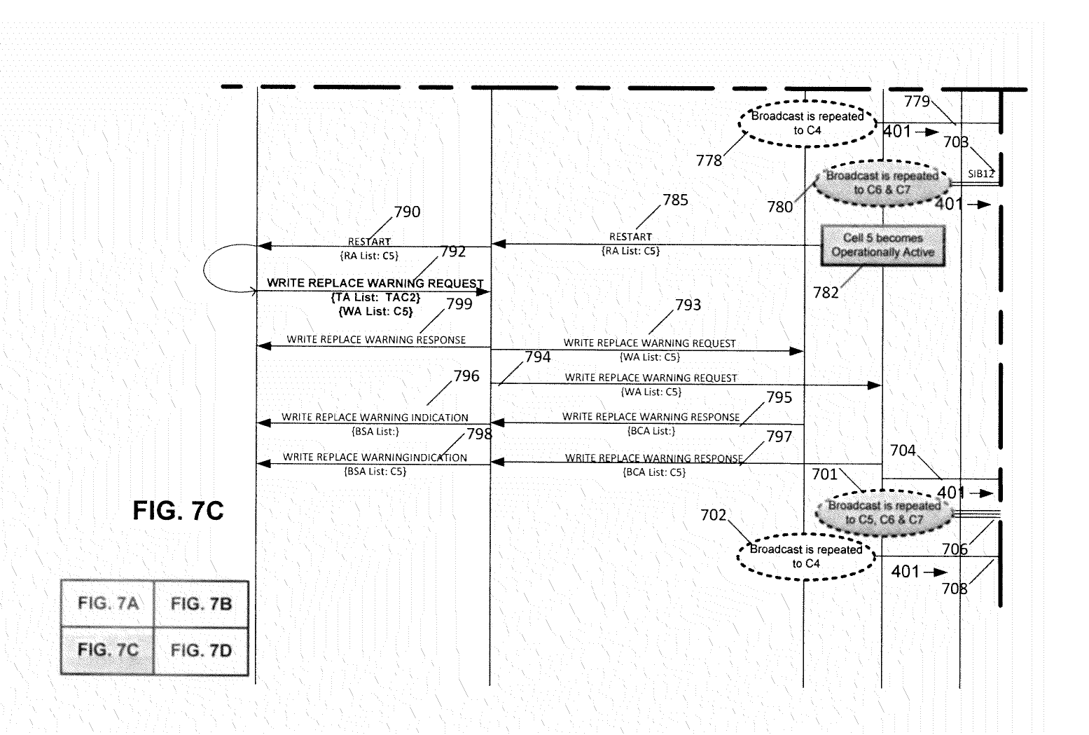

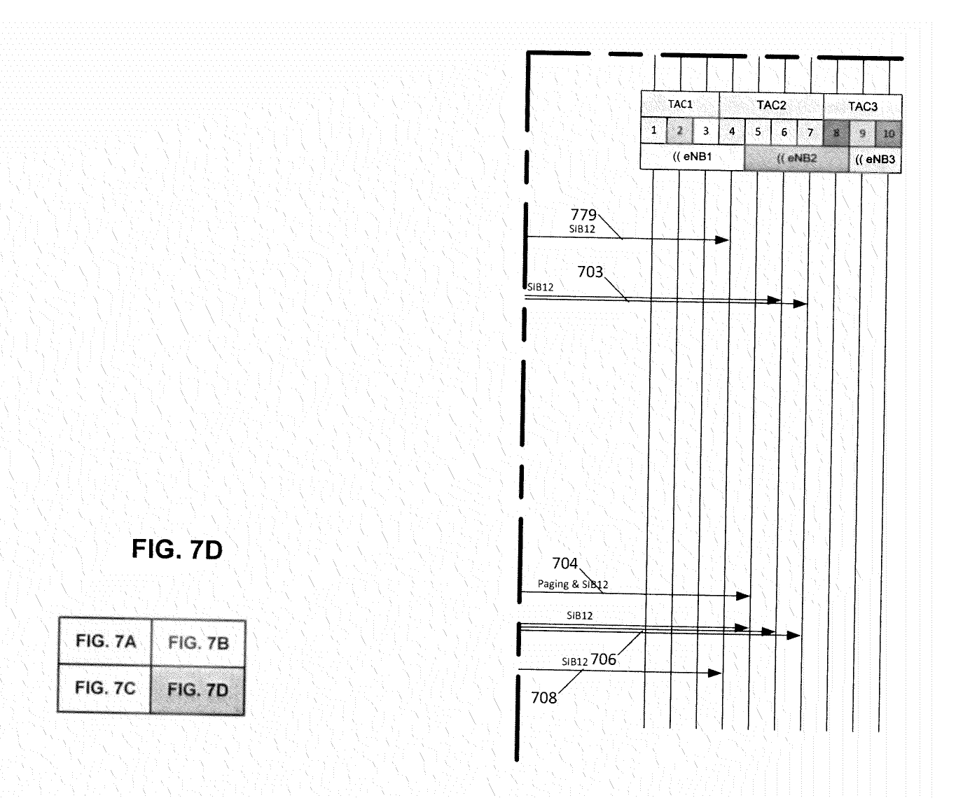

FIG. 7 illustrates another example similar to the example in FIG. 5. FIG. 7 includes FIGS. 7A, 7B, 7C, and 7D and is a signaling and flow diagram illustrating a partial failure scenario of re-using 2G/3G PWS concepts. In this example, the CBC 190 is going to send (block 705) a warning message 401 to TAC2 480-2, which includes cell 4, cell 5, cell 6 and cell 7. Block 710 and reference 706 indicate that cell 4 is operationally down. Similarly, block 711 and reference 707 indicate that cell 5 is operationally down, while block 712 and reference 708 indicate that cell 10 is operationally down.

The CBC 190 sends message 715, a Write Replace Warning Request, which includes a TA list of TAC2 and a WA list of TAC2 to MME 180. The MME 180 responds to the CBC 190 with a Write Replace Warning Response message 720. The MME 180 in response sends a Write Replace Warning Request message 725, with a WA list of TAC2 to eNB1 170-1 and a Write Replace Warning Request message 730, with a WA list of TAC2 to eNB2 170-2. The eNB2 170-2 sends paging and SIB12 signaling 731 to UE(s) in cells 6 and 7.

The eNB1 responds with a Write Replace Warning Response message 735, with an empty Broadcast completed area list, BCA list, since cell 4 is down and is the only cell in TAC2 to which the eNB1 is assigned. The MME 180 responds by sending a Write Replace Warning Indication message 740 to the CBC 190, where message 740 has a blank Broadcast Scheduled Area list, BSA list. The eNB2 responds with a Write Replace Warning Response message 745, with a BCA list of TAC2 and indications of cells C6 and C7. The MME 180 responds by sending a Write Replace Warning Indication message 750 to the CBC 190, where the message 750 has a BSA list of TAC2 and indications of cells C6 and C7. In reference 755, the eNB 170-2 repeats the broadcasting of the warning message 401 to UEs 110 in cells C6 and C7 via SIB messages 732.

Block 760 indicates that cell 4 350-4 becomes operationally active. The eNB 1 170-1 sends a Restart message 763 with a restart cell-list, RA list of C4 to the MME 180, which forwards message 763 as message 765 to the CBC 190. The CBC 190 responds with a Write Replace Warning Request message 767, containing indications of the TA list of TAC2 and the WA list of C4. The MME 180 responds with a Write Replace Warning Indication message 770. The MME also sends a Write Replace Warning Request message 769, with a WA list of C4, to the eNB1 170-1. The MME 180 also sends a Write Replace Warning Request message 772, with a WA list of C4, to the eNB2 170-2. The eNB1 170-1 responds with a Write Replace Warning Response message 773, with a BCA list of C4. The eNB I also sends paging and SIB12 signaling 774 to UE(s) in cell 4 350-4. The MME 180 receives message 773 and sends a Write Replace Warning Indication message 775, with BSA list of C4, to the CBC 190. The eNB2 170-2 responds to message 772 with a Write Replace Warning Response message 776, with a BCA list that is blank. It is noted the BCA list is blank because at this point, WA list=C4, C4 is not served by eNB2, so eNB2 does not initiate broadcast in any cell as a result of this Write Replace Warning Response message. The MME 180 receives message 776 and sends a Write Replace Warning Indication message 777, with BSA list that is blank, to the CBC 190. Reference 778 indicates that the eNB1 repeats the broadcasting of the warning message 401 to cell C4 via SIB12 message 779. Reference 780 indicates that the eNB2 repeats the broadcasting of the warning message 401 to UEs 110 in cells C6 and C7 via SIB 12 messages 703.

Block 782 indicates that cell 5 350-5 becomes operationally active. The eNB2 170-2 sends a Restart message 785 with an RA list of C5. Responsive to message 785, the MME 180 sends a Restart message 790 with the RA list of C5 to the CBC 190. The CBC 190 responds with a Write Replace Warning Request message 792 having a TA list of TAC2 and a WA list of C5. The MME 180 sends a Write Replace Warning Response message 799 to the CBC 190. The MME 180 also sends a Write Replace Warning Request message 793 to the eNB1 170-1 and sends a Write Replace Warning Request message 794 to the eNB 2 170-2. The eNB 1 170-1 responds to the MME 180 with a Write Replace Warning Response message 795 with a blank BCA list), and the eNB2 170-2 responds to the MME 180 with a Write Replace Warning Response message 797 (with a BCA list of CS). Responsive to message 795, the MME 180 sends a Write Replace Warning Indication message 796 with a blank BSA list. Responsive to message 797, the MME 180 sends a Write Replace Warning Indication message 798 with a BSA list of C5.

The eNB2 170-2 sends paging and SIB12 signaling 704 to UE(s) in cell C5 350-5. As indicated by reference 701, the eNB2 170-2 repeats the broadcasted warning message 401 to UEs 110 in cells C5, C6, and C7 via SIB12 messages 706. As indicated by reference 702, the eNB 1 170-1 repeats the broadcasted warning message 401 to UEs 110 in cell C4 via SIB12 message 708.

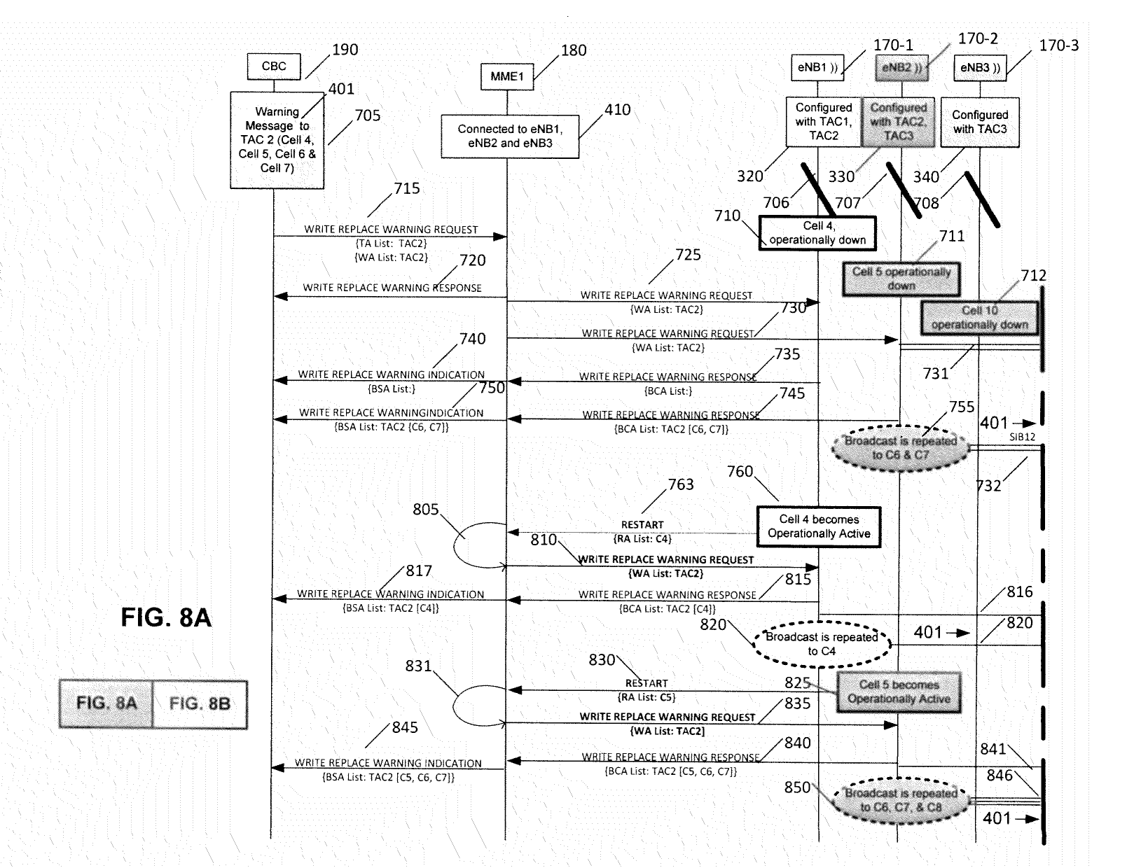

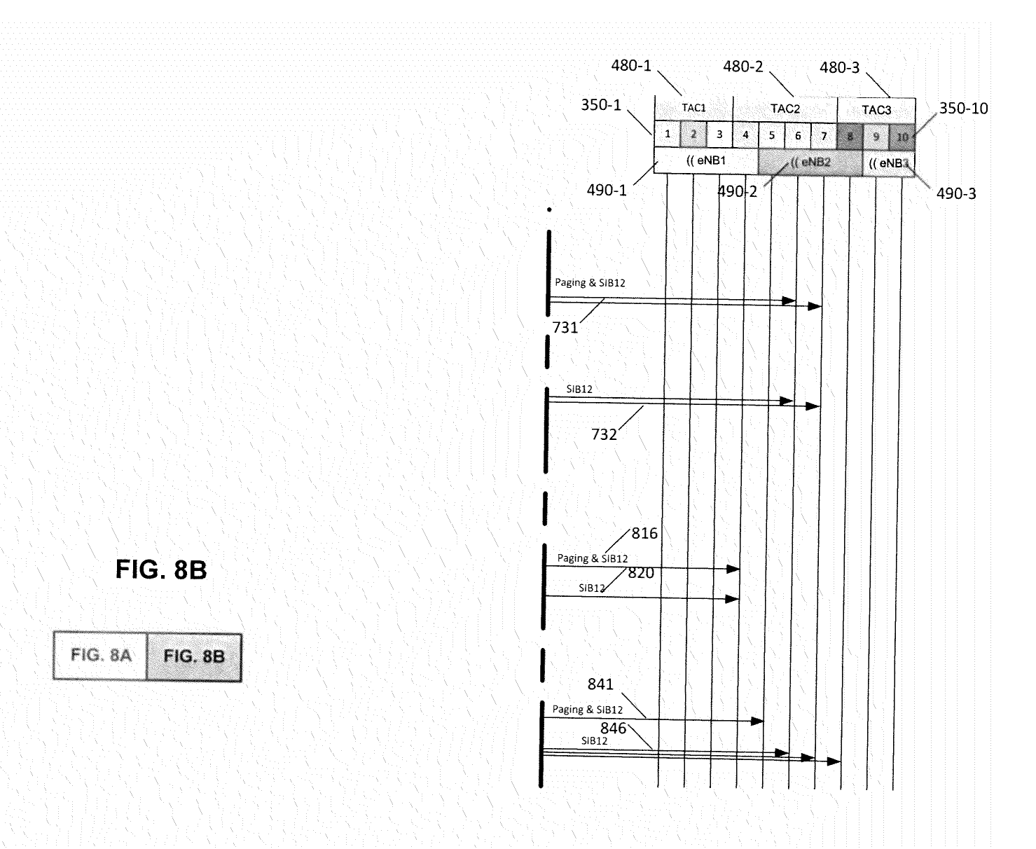

In FIG. 7, the broadcast in reference 780 is unnecessary, as cells C6 and C7 already have received the broadcasted warning message. The broadcast in reference 702 is also unnecessary, as cell C4 has already have received the broadcasted warning message. The exemplary embodiment of FIG. 8 shows techniques for ensuring these unnecessary signaling and broadcasts are not performed.

Turning to FIG. 8, which includes FIGS. 8A and 8B, this figure is a signaling and flow diagram illustrating a partial failure scenario in an exemplary embodiment herein. The operations in FIG. 8 are the same as those in FIG. 7 until the Restart message 763, containing the RA list of C4, from the eNB 1 170-1 to the MME 180. At this point, in reference 805, the MME 180 determines that cell C4 350-4 has restarted and determines to send and sends to eNB1a Write Replace Warning Request message 810 with a WA list of TAC2. The eNB1 170-1 sends a Write Replace Warning Response message 815 with a BCA list of TAC2 and an indication of cell C4. The MME 180 sends a Write Replace Warning Indication message 817 to the CBC 190. The message 817 includes a BSA list with an indication of TAC2 and an indication of cell C4. The eNB1 170-1 performs paging and SIB12 signaling 816 to UE(s) in cell C4 350-4. As indicated by reference 820, the eNB1 170-1 repeats the broadcasting of warning message 401 to UE(s) 110 in cell C4 via SIB 12 message 820.

In block 825, the cell C5 350-5 becomes operationally active and sends a Restart message 830 with an RA list of C5 to the MME. The MME 180, in reference 831, determines that cell C5 has restarted and determines to send and sends to eNB2 a Write Replace Warning Request message 835 with a WA list of TAC2. The eNB2 170-2 performs paging and SIB12 841 signaling to UE(s) in cell C5 350-5. The eNB2 170-2 responds to the MME with a Write Replace Warning Response message 840, having a BCA list of TAC2 and indications of the cells C5, C6, and C7. The MME 180 sends a Write Replace Warning Indication message 845 having a BSA list of TAC2 and indications of the cells C5, C6, and C7. As indicated by reference 850, the eNB2 170-2 repeats the broadcasting of the warning message 401 to UE(s) in cells C6. C7, and CS via SIB12 messages 846.

It can be seen in FIG. 8 (and relative to FIG. 7) that there is less signaling and fewer redundant broadcasts of the warning message 401 to cells that have already received the warning messages. The exemplary embodiment in FIG. 8 is therefore an improvement over the techniques shown in FIG. 7.

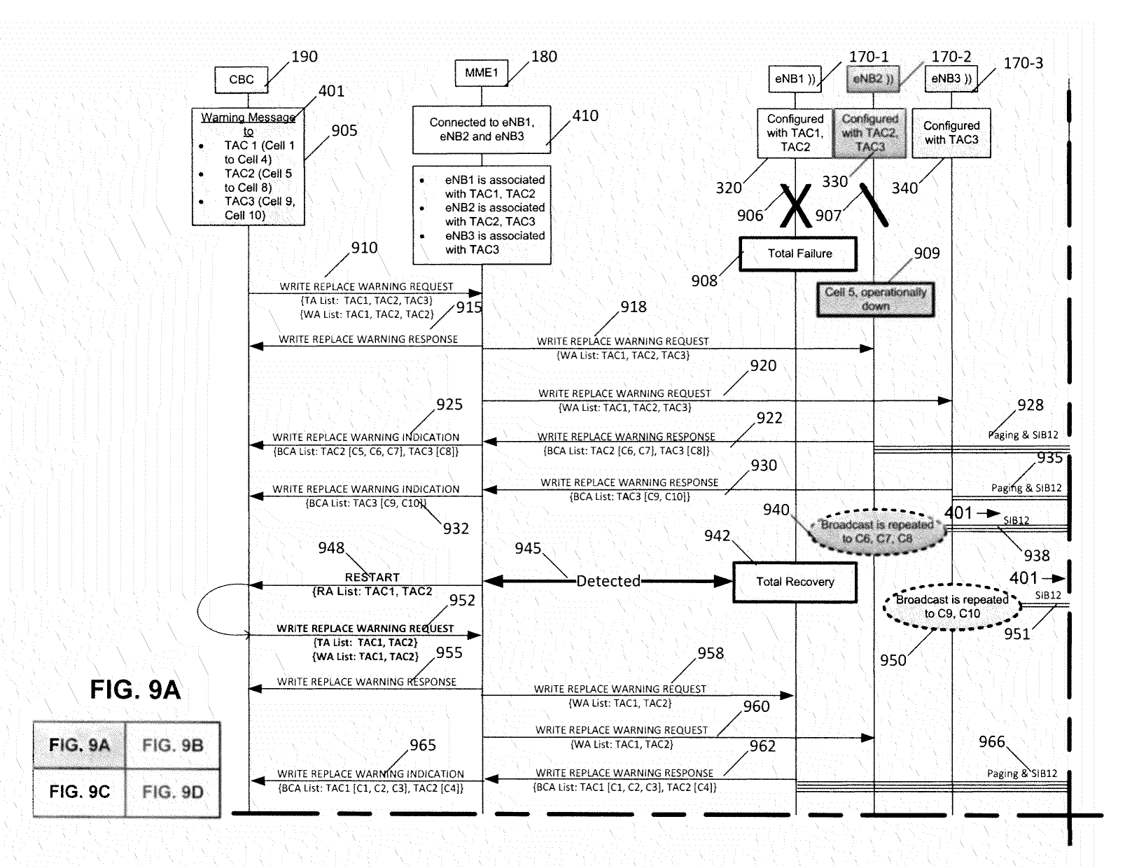

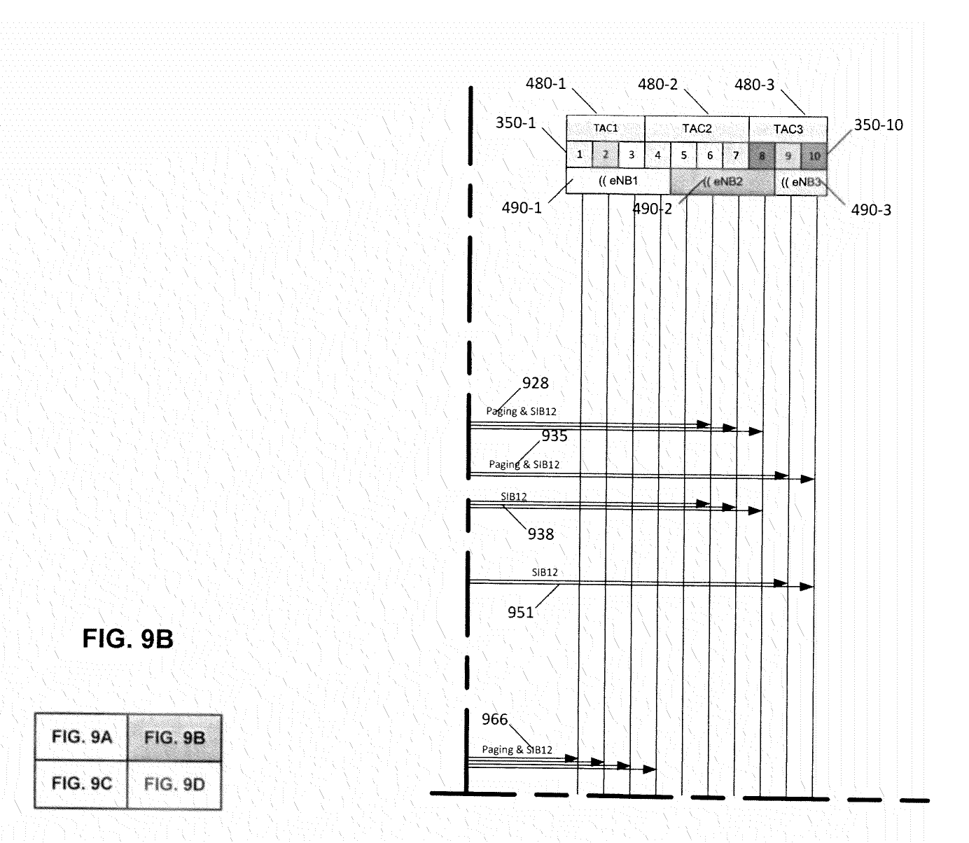

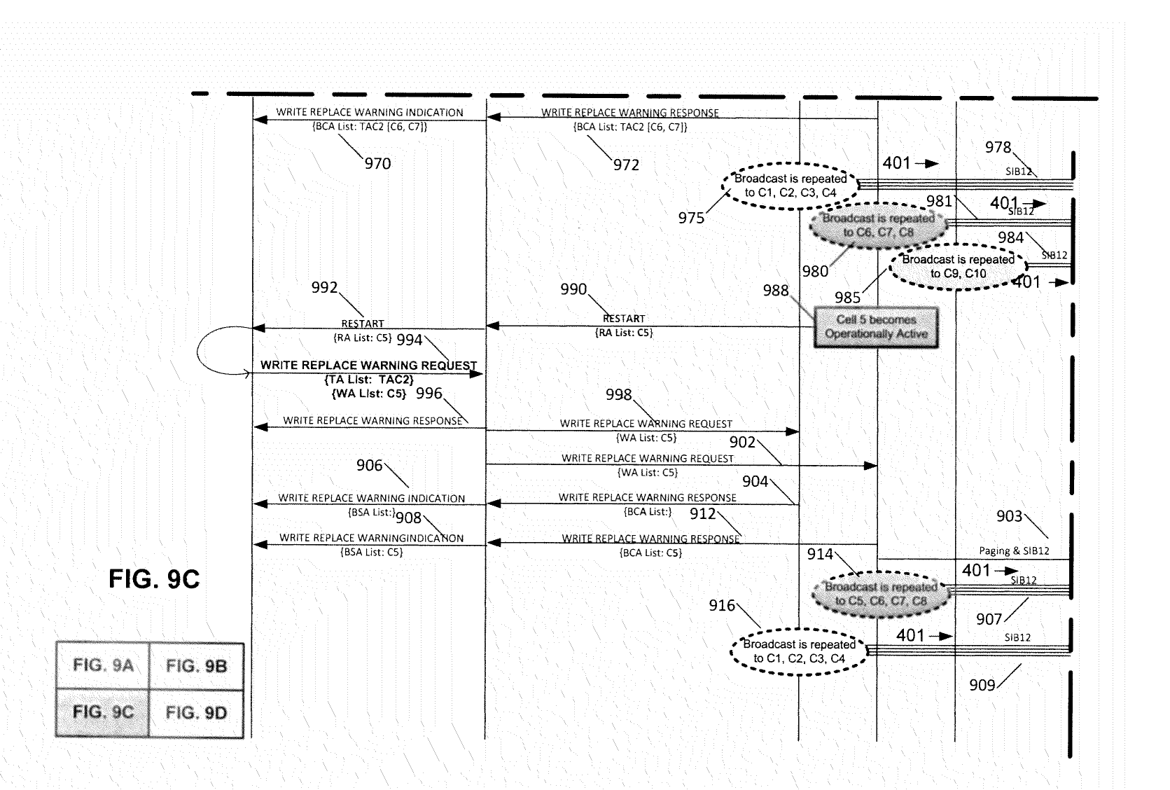

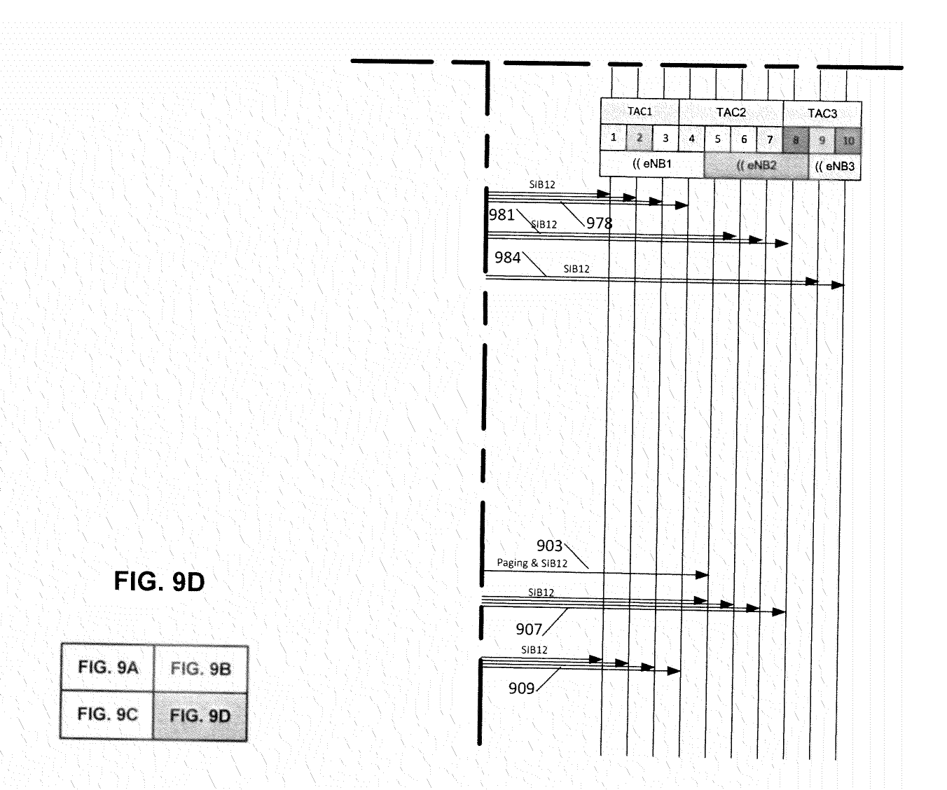

FIG. 9 is another example of problems associated with failures, in this case a total of an eNB and a partial failure of an eNB. FIG. 9 includes FIGS. 9A, 9B, 9C, and 9D and is a signaling and flow diagram illustrating total and partial failure cases, illustrating a problem with 2G/3G importation into LTE. In block 905, the warning message 401 is to be broadcast to TAC 1 480-1 (Cell 1 to Cell 4), TAC2 480-2 (Cell 5 to Cell 8), and TAC3 480-3 (Cell 9, Cell 10). Block 908 and element 906 indicate that the eNB 1 170-1 has a total failure, meaning that cells C1 350-1 through C4 350-4 are operationally down. Additionally, block 909 and element 907 indicate that cell 5 of eNB2 170-2 is operationally down, and thus eNB2 170-2 has a partial failure (as cells C6, C7, and C8 are operationally active).

The CBC 190 sends a Write Replace Warning Request message 910 containing a TAC list of TAC1, TAC2, and TAC3, and a WA list of TAC1, TAC2, and TAC3. The MME 180 responds with a Write Replace Warning Response message 915. The MME 190 sends Write Replace Warning Request messages 918, 920 to eNBs 170-2 and 170-3 with a WA list comprising indications of TAC1, TAC2, and TAC3. The eNB2 170-2 responds with a Write Replace Warning Response message 922 having a BCA list of TAC2 and indications of cells C6 and C7, and TAC3 and an indication of cell C8. The eNB2 170-2 sends paging and SIB12 signaling 928 to LIE(s) in cells C6, C7, and C8. The eNB3 170-3 responds with a Write Replace Warning Response message 930 having a BCA list of TAC3 and indications of cells C9 and C10. The eNB3 170-3 sends paging and SIB12 signaling 935 to UE(s) in cells C9 and C10.

Responsive to message 922, the MME 180 sends a Write Replace Warning Indication message 925, comprising a BCA list with indications of TAC2 (and indications of cells C5, C6, and C7) and TAC3 (and an indication of cell C8). Responsive to message 930, the MME 180 sends a Write Replace Warning Indication message 932, comprising a BCA list with an indication of TAC3 (and indications of cells C9 and C10).

In reference 940, the eNB 170-2 repeats the broadcasting of the warning message 401 to UE(s) 110 in cells C6, C7, and C8 via SIB messages 938. In reference 950, the eNB 170-3 repeats the broadcasting of the warning message 401 to UE(s) in cells C9 and C10 via SIB messages 951.

Block 942 indicates that eNB1 170-1 has a total recovery. The total recovery is detected by the MME 180 via signaling 945. The MME 180 sends a Restart message 948, comprising the RA list with indications of TAC1 and TAC2, to the CBC 190. The CBC 190 responds with a Write Replace Warning Request message 952 containing the TA list with indication of TAC 1 and TAC 2 and a WA list with indications of TAC1 and TAC2. The MME 180 responds with a Write Replace Warning Response message 955.

The MME 180 then sends Write Replace Warning Request messages 958, 960 to eNBs 170-1 and 170-2, respectively. The eNB1 170-1 responds with a Write Replace Warning Response message 962 having a BCA list with indications of TAC1 (and indications of cells C1, C2, and C3) and TAC2 (and an indication of cell C4). The MME 180 sends a Write Replace Warning Indication message 965, with a BCA list with indications of TAC1 (and indications of cells C1, C2, and C3) and TAC2 (and an indication of cell C4), to the CBC 190. The eNB1 170-1 sends paging and SIB12 signaling 966 to the UE(s) in cells C1, C2, C3, and C4.

The eNB2 170-2 responds (to message 960) with a Write Replace Warning Response message 972 having a BCA list with an indications of TAC2 (and indications of cells C6 and C7). The MME 180 sends a Write Replace Warning Indication message 970, with a BCA list with an indications of TAC2 (and indications of cells C6 and C7), to the CBC 190.

In reference 975, the eNB 170-1 repeats the broadcasting of the warning message 401 to UE(s) 110 in cells C1, C2, C3, and C4 via SIB messages 978. In reference 980, the eNB 170-2 repeats the broadcasting of the warning message 401 to UE(s) 110 in cells C6, C7, and C8 via SIB messages 981. In reference 985, the eNB 170-3 repeats the broadcasting of the warning message 401 to UE(s) in cells C9 and C 10 via SIB messages 984.

As block 988 indicates, cell 5 350-5 becomes operationally active and sends a Restart message 990 with an RA list including an indication of cell C5 to the MME 180. The MME 180 sends a Restart message 992 with an RA list including an indication of cell C5 to the CBC 190. The CBC 190 responds with a Write Replace Warning Request message 994 comprising a TA list with an indication of TAC2 and a WA list with an indication of cell C5. The MME 180 responds with a Write Replace Warning Response message 996.

The MME 180 sends Write Replace Warning Request messages 998, 902 with a WA list including an indication of cell C5 to the eNBs 170-1 and 170-2, respectively. The eNB1 170-1 responds with a Write Replace Warning Response message 904 including a blank BCA list. The MME 180 forwards a version of the message 904 to the CBC 190 as message 906. The eNB1 170-2 responds with a Write Replace Warning Response message 912 including a BCA list with an indication of cell C5. The MME 180 forwards a version of the message 912 to the CBC 190 as message 908.

The eNB2 170-2 sends paging and SIB12 signaling 903 to the UE(s) in cell C5 350-5. In reference 914, the eNB 170-2 repeats the broadcasting of the warning message 401 to UE(s) 110 in cells C5, C6, C7, and C8 via SIB messages 907. In reference 916, the eNB 170-3 repeats the broadcasting of the warning message 401 to UE(s) 110 in cells C1, C2, C3, and C4 via SIB messages 909.

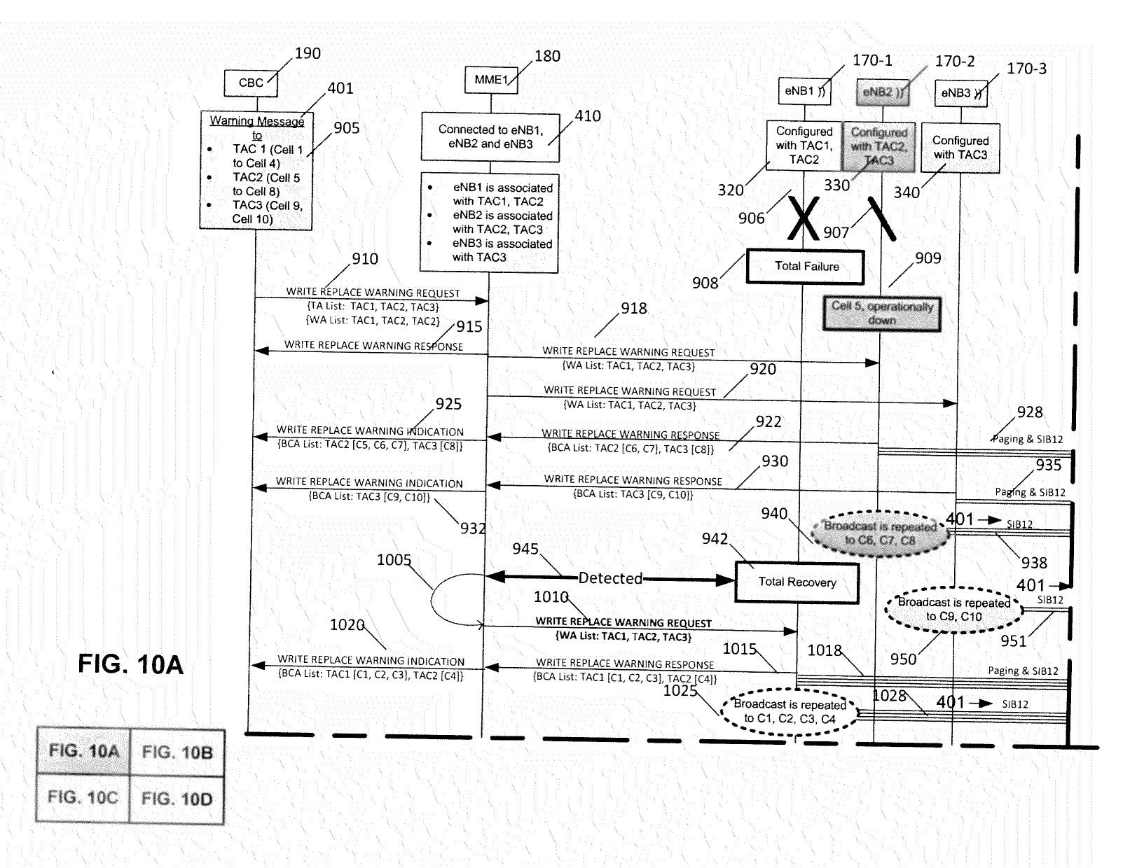

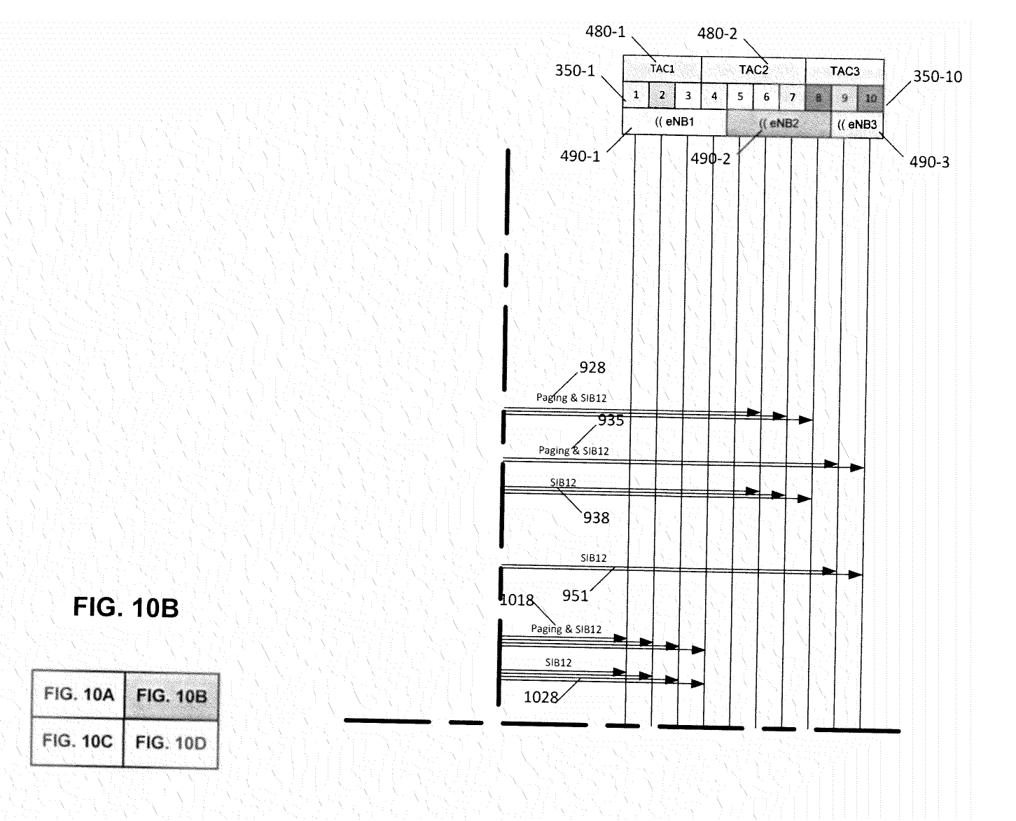

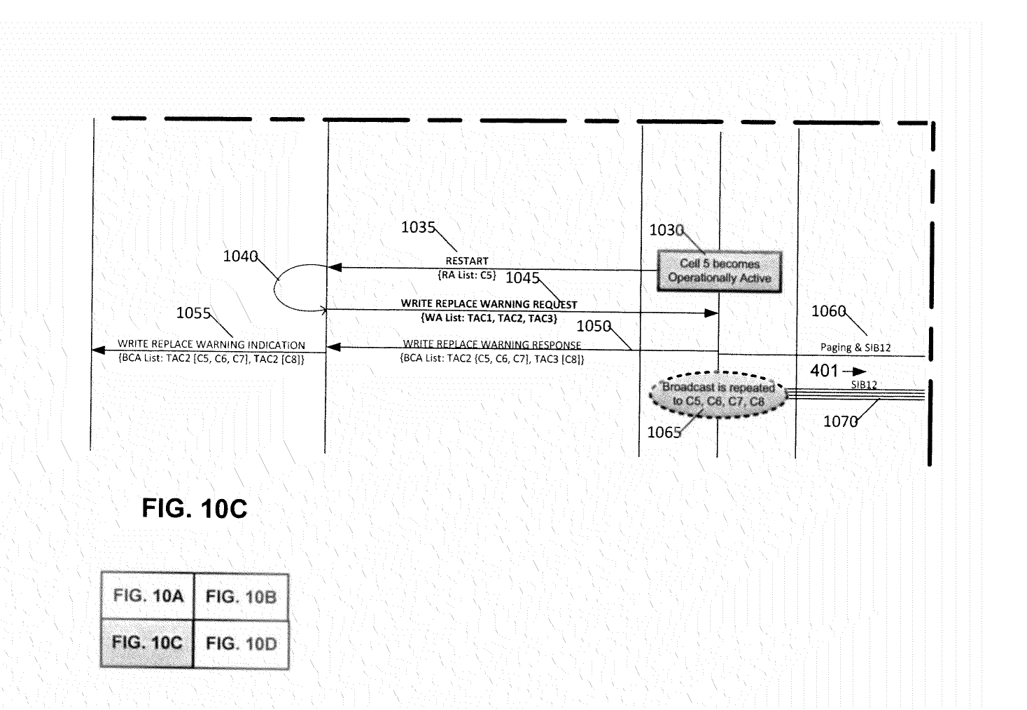

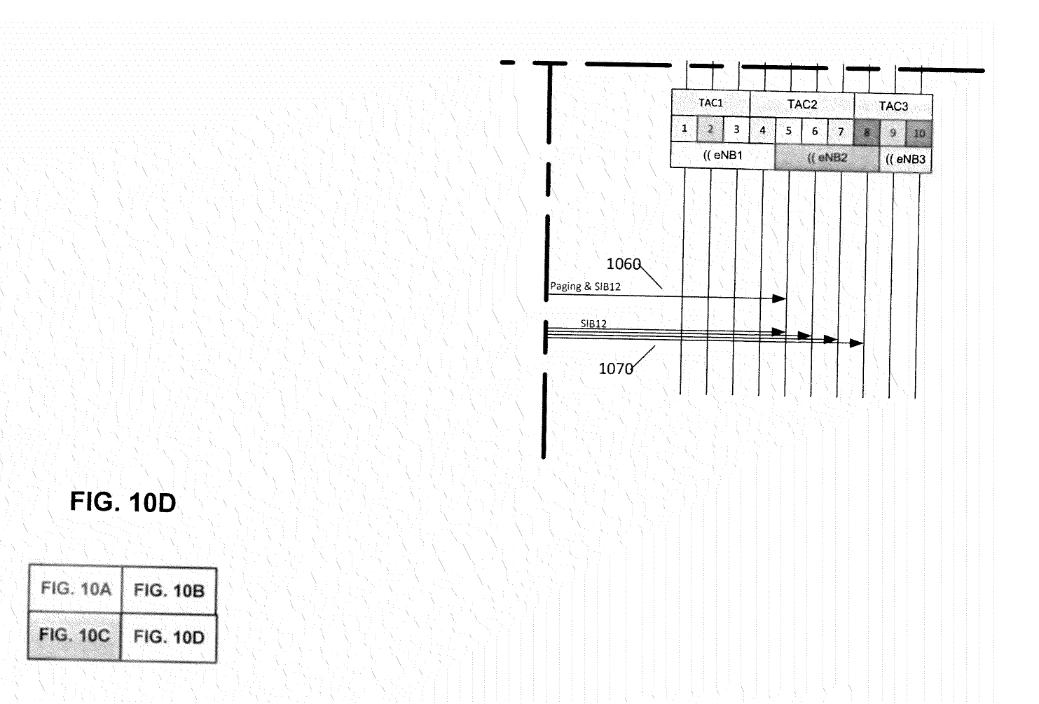

FIG. 9 illustrates that the broadcasts in at least references 980 and 916 are superfluous. FIG. 10 provides an example in accordance with an exemplary embodiment where these superfluous broadcasts are not performed.

FIG. 10, including FIGS. 10A, 10B, 10C, and 10D, is a signaling and flow diagram illustrating total and partial failure cases in an exemplary embodiment. FIG. 10 is the same as FIG. 9 until the MME 180 responds to the detection of signaling 945 that the eNB1 170-1 has totally recovered. At this point, the MME 180 determines in reference 1005 that the total recovery of eNB1 has occurred and responds by sending a Write Replace Warning Request message 1010 to the eNB1 170-1, where the message 1010 includes the WA list of TAC1, TAC 2, and TAC3. The reason for TACs 1-3 is MME may not actually manage the WA list. This list is only used by the eNB. The MME simply stores the WA list as the list is received from the CBC and forwards the list as is when the eNB becomes operationally active. The eNB1 170-1 responds to the MME 180 with a Write Replace Warning Response message 1015 with a BCA list having indications of TAC1 (and indications of cells C1, C2, and C3) and TAC 2 (and an indication of cell C4). The MME 180 sends a Write Replace Warning Indication message 1020 to the CBC 190, where the message 1020 includes a BCA list having indications of TAC1 (and indications of cells C1, C2, and C3) and TAC 2 (and an indication of cell C4). The eNB 170-1 sends paging and SB 12 signaling 1018 to the UE(s) in cells C1, C2, and C3. In reference 1025, the eNB 170-1 repeats the broadcasting of the warning message 401 to LIE(s) 110 in cells C1, C2, C3. and C4 via SIB messages 1028,

Block 1030 indicates that cell 5 has become operationally active. The eNB2 170-2 sends a Restart message 1035 with an RA list comprising an indication of cell C5. Reference 1040 indicates the MME 180 receives the restart indication and in response, sends a Write Replace Warning Request message 1045 to the eNB2 170-2. The message 1045 includes a WA list with indications of TAC1, TAC2, and TAC3. The eNB2 170-2 responds to the MME 180 with a Write Replace Warning Response message 1050 having a BCA list including indications of TAC2 (and indications of cells C5, C6. C7, and C8) and TAC3 (and an indication of cell C8). The MME 180 sends a Write Replace Warning Indication message 1055 including the BCA list including indications of TAC2 (and indications of cells C5, C6, C7, and C8) and TAC3 (and an indication of cell C8). The eNB 170-2 sends paging and SB 12 signaling 1060 to the UE(s) in cell C5. The eNB2 170-2 in reference 1065 repeats the broadcasting of the warning message 401 to UE(s) 110 in cells CS. C6, C7, and C8 via SIB messages 1070.

FIG. 10 therefore shows (relative to FIG. 9) less signaling and fewer extraneous broadcasting of warning messages. Therefore, the techniques in FIG. 10 have benefits over the techniques in FIG. 9.

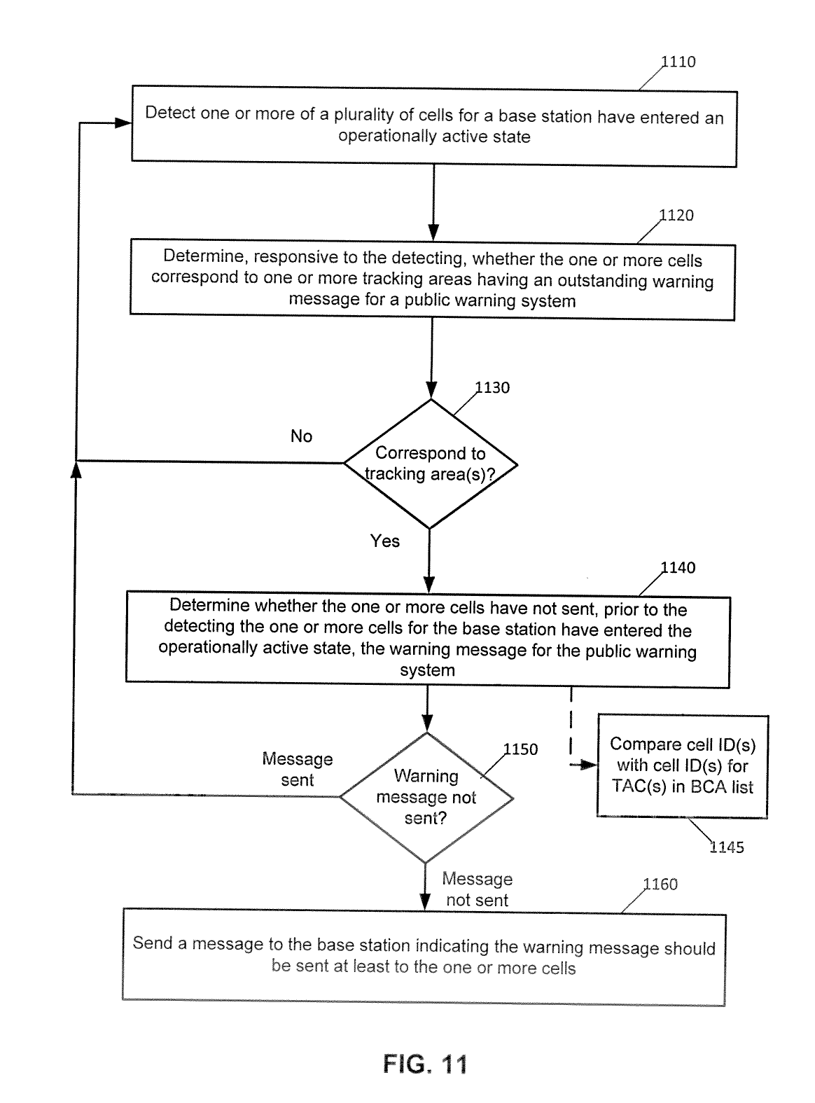

Referring to FIG. 11, FIG. 11 is a block diagram of an exemplary logic flow diagram for addressing “eNB Partial Failure” for a public warning system. FIG. 11 is a diagram that illustrates the operation of an exemplary method, a result of execution of computer program instructions embodied on a computer readable memory, and/or functions performed by logic implemented in hardware, in accordance with exemplary embodiments herein. The interconnected blocks in FIG. 11 may be, e.g., software sections, hardware elements, or means that perform the functions in the blocks. The blocks in FIG. 11 are performed by MME 180.

In block 1110, the MME 180 detects one or more of a plurality of cells for a base station have entered an operationally active state. This detection could be by receiving a restart message (see, e.g., Restart message 1035 of FIG. 10) or could be via signaling (see signaling 945 of FIG. 10) indicating an entire eNB 170 has recovered. In block 1120, the MME 180 determines, responsive to the detecting, whether the one or more cells correspond to one or more tracking areas having an outstanding warning message for a public warning system. For instance, the MME 180 receives a Write Replace Warning Request message 910 containing both TA and WA lists and corresponding TACs 480. The MME 180 has a TAC-to-eNB mapping and can determine therefore whether the one or more cells 350 corresponding to the tracking areas having the outstanding warning message 401 for a public warning system. It is noted that the public warning can end. For instance, the CBC can send Stop Warning Messages to stop the public warning. Should the MME 180 determine that the public warning has ended (e.g., relative to a cell that has entered an operationally active state), the MME 180 could determine in block 1120 that the cell does not correspond to the outstanding public warning message.

If the MME 180 determines the one or more cells 350 corresponding to the tracking areas or tracking areas do not have the outstanding warning message 401 for a public warning system (block 1130=No), the flow proceeds to block 1110. If the MME 180 determines the one or more cells 350 corresponding to the tracking areas or the tracking areas do have the outstanding warning message 401 for a public warning system (block 1130=Yes), the flow proceeds to block 1140.

In block 1140, the MME 180 determines whether the one or more cells have not sent, prior to the detecting the one or more cells for the base station have entered the operationally active state, the warning message for the public warning system. Such a determination could be made (block 1145) by comparing cell ID(s) of the one or more cell(s) (e.g., or an ID of the base station) with cell ID(s) (or base station IDs) for TAC(s) in a BCA list. If the warning message has already been sent (block 1150=Message sent), flow proceeds to block 1110. If the warning message has not already been sent (block 1150=Message not sent), in block 1160, the MME 180 sends a message to the base station indicating the warning message should be sent at least to the one or more cells.

It should be noted that one exemplary embodiment is to not perform blocks 1140 and 1150. In this exemplary embodiment, the MME 180 would then always broadcast the warning message 410 to any cells 350 (e.g., in a corresponding TAC) in response to the cell 350 becoming operationally active.

Primary emphasis above has been placed on option (1). However, for option (2) (an eNB 170 performs auto restart and notifies the CBC 190 with a restart message), an exemplary method is for the eNB to remember the alert broadcast information (e.g., the warning message 401 and the corresponding TACs) and the eNB automatically restarting the message. In this approach, the eNB will send a Restart message to the MME with a flag indicating that an auto-restart occurred at the eNB. The MME will simply forward the Restart message to the CBC. The CBC does not act upon the Restart message. Instead, the Restart message just is used to inform the CBC that the broadcast has been automatically started in a recovered cell.

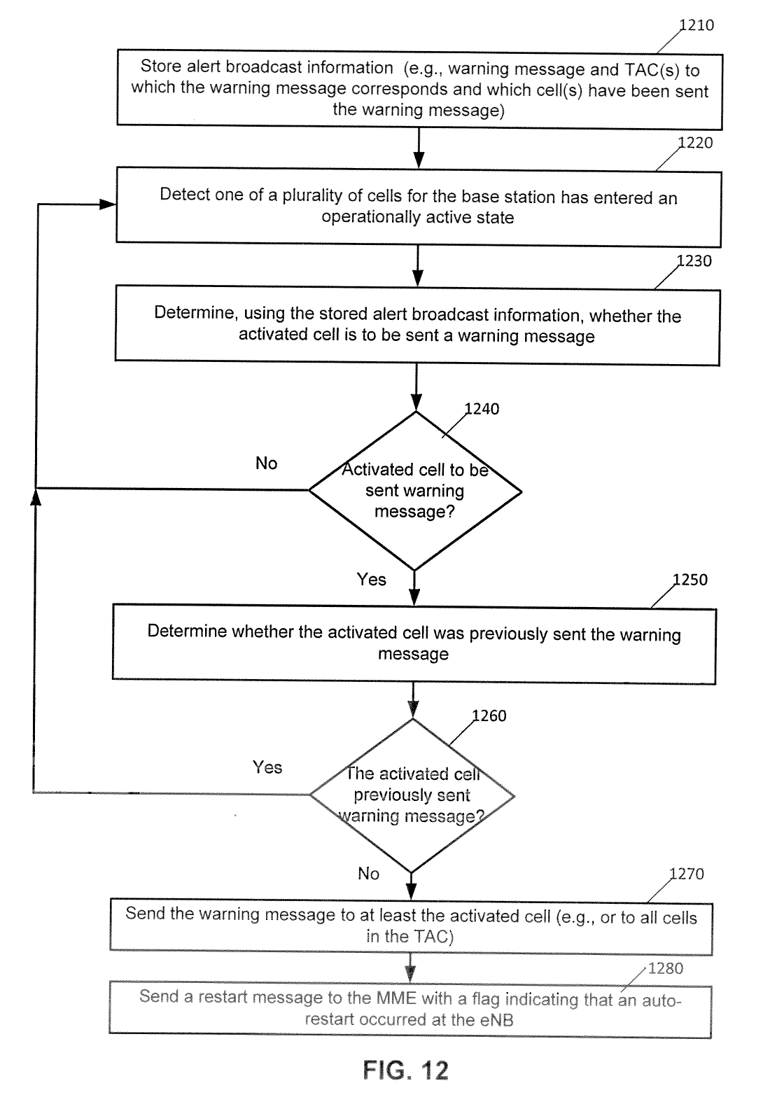

Referring to FIG. 12, FIG. 12 is a block diagram of an exemplary logic flow diagram for addressing “eNB Partial Failure” for a public warning system. FIG. 12 is a diagram that illustrates the operation of an exemplary method, a result of execution of computer program instructions embodied on a computer readable memory, and/or functions performed by logic implemented in hardware, in accordance with exemplary embodiments herein. The interconnected blocks in FIG. 12 may be, e.g., software sections, hardware elements, or means that perform the functions in the blocks. The blocks in FIG. 12 are performed by a base station such as an eNB 170.

In block 1210, the base station stores alert broadcast information (e.g., warning message and TAC(s) to which the warning message corresponds and which cell(s) have been sent the warning message). In block 1220, the base station detects one of a plurality of cells for the base station has entered an operationally active state. The base station, in block 1230, determines, using the stored alert broadcast information, whether the activated cell is to be sent a warning message. As an example, every time a cell enters an operationally active state, the just-activated cell (or all of the cells) might be sent an outstanding warning message. Block 1230 can include determining, using the stored alert broadcast information, whether the cell corresponds to the TAC for the outstanding broadcast message. If not, then block 1240=No, and flow proceeds to block 1220. If so, then block 1240=Yes, and flow proceeds to block 1250.

If the activated cell is not to be sent the warning message (block 1240=No), the flow goes back to block 1220. If the activated cell is to be sent the warning message (block 1240=Yes), block 1250 is performed. The base station in block 1250 determines whether the activated cell was previously sent the warning message. If the activated cell was previously sent the outstanding warning message (block 1260=Yes), the flow continues in block 1220. If the activated cell was not previously sent the outstanding warning message (block 1260=No), the flow proceeds to block 1270. Note, as stated above, it may be a rule that a recently activated cell is always sent an outstanding warning message, regardless of whether the activated cell has previously received the warning message.

In block 1270, the base station sends the warning message to at least the UE(s) in the activated cell (e.g., or to UE(s) in all cells in the TAC). In block 1280, the base station sends a restart message to the MME with a flag indicating that an auto-restart occurred at the eNB.

The two methods (MME-based auto start and eNB-based auto start) can co-exist in the same system with the inclusion of a flag into the Restart message. If someone wants to implement the method of imported concept from 2G/3G i.e. failure/restart indications to CBC (as shown in FIGS. 5, 7, and 9), the methods invented here can still co-exist with that approach.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 2. A computer-readable medium may comprise a computer-readable storage medium (e.g., memory(ies) 155, 195 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

2G second generation

3G third generation

3GPP third generation partnership project

BCA Broadcast Completed Area

BSA Broadcast Scheduled Area

CBC Cell Broadcast Center

CBE Cell Broadcast Entity

Cell ID Cell Identity

ECGI Enhanced Cell Global Identity

eNB evolved Node B (e.g., LTE base station)

EPS Evolved Packet System

E-UTRAN Evolved UTRAN

GPRS General Packet Radio System

HSS Home Subscriber Server

LTE Long Term Evolution

MME Mobility Management Entity

PDN-GW Packet Data Network Gateway

PLMN Public Land Mobile Network

P-GW Packet Gateway

PWS Public Warning System

RA Restart cell

RNC Radio Network Controller

SAI Service Area Identity

S-GW Serving Gateway

SIB System Information Block

TA Tracking Area

TAC Tracking Area Code

TAI Tracking Area Identity

TS Technical Standard

UE User Equipment

UTRAN Universal Terrestrial Radio Access Network

WA Warning Area

What is claimed is:

1. An apparatus, comprising:
one or more processors; and
one or more memories including computer program code,
the one or more memories and the computer program code configured, with the one or more processors, to cause the apparatus to perform at least the following:
detecting one or more of a plurality of cells for a base station have entered an operationally active state;
determining, responsive to the detecting, whether the one or more cells correspond to one or more tracking areas having an outstanding warning message for a public warning system; and
sending, in response to the detecting and to a determination the one or more cells correspond to the one or more tracking areas having the outstanding warning message for the public warning system, a message to the base station indicating the warning message should be sent at least to the one or more cells.

2. The apparatus of claim 1, wherein:
the one or more memories and the computer program code are further configured, with the one or more processors, to cause the apparatus to perform at least: determining, prior to sending, the one or more cells have not sent, prior to the detecting the one or more cells for the base station have entered an operationally active state, the warning message for the public warning system; and
sending further comprises sending, in response to the detecting, to the determination the one or more cells correspond to the one or more tracking areas having the outstanding warning message for the public warning system, and to determining the one or more cells have not sent the warning message for the public warning system prior to the detecting the one or more cells for the base station have entered an operationally active state, the message to the base station indicating the warning message should be sent at least to the one or more cells.

3. The apparatus of claim 2, wherein determining the one or more cells have not sent the warning message for the public warning system prior to the detecting the one or more cells for the base station have entered an operationally active state further comprises determining the one or more cells have not sent the warning message by comparing information in a broadcast completed area list from a message received from the base station with identification of one or more cells, wherein a determination is made the one or more cells have not sent the warning message in response to identification of the one or more cells not being in the broadcast completed area list.

4. The apparatus of claim 1, wherein:
the one or more cells of the base station comprise all of the plurality of cells of the base station; and
detecting the one or more cells for the base station have entered an operationally active state further comprises detecting via signaling a total recovery of the base station.

5. The apparatus of claim 1, wherein:
the one or more cells of the base station comprise a single cell of the cells of the base station; and
detecting the one or more cells for the base station have entered an operationally active state further comprises detecting a restart message from the single cell.

6. The apparatus of claim 1, wherein each of the one or more tracking areas corresponds to a unique tracking area code.

7. The apparatus of claim 1, wherein sending further comprises sending a write replace warning request message to the base station, wherein the write replace warning request message comprises an indication of one or more tracking area codes to which the one or more cells correspond.

8. A method, comprising:
detecting one or more of a plurality of cells for a base station have entered an operationally active state;
determining, responsive to the detecting, whether the one or more cells correspond to one or more tracking areas having an outstanding warning message for a public warning system; and
sending, in response to the detecting and to a determination the one or more cells correspond to the one or more tracking areas having the outstanding warning message for the public warning system, a message to the base station indicating the warning message should be sent at least to the one or more cells.

9. The method of claim 8, wherein:
the method further comprises determining, prior to sending, the one or more cells have not sent, prior to the detecting the one or more cells for the base station have entered an operationally active state, the warning message for the public warning system; and
sending further comprises sending, in response to the detecting, to the determination the one or more cells correspond to the one or more tracking areas having the outstanding warning message for the public warning system, and to determining the one or more cells have not sent the warning message for the public warning system prior to the detecting the one or more cells for the base station have entered an operationally active state, the message to the base station indicating the warning message should be sent at least to the one or more cells.

10. The method of claim 8, wherein:
the one or more cells of the base station comprise all of the plurality of cells of the base station; and
detecting the one or more cells for the base station have entered an operationally active state further comprises detecting via signaling a total recovery of the base station.

11. The method of claim 8, wherein:
the one or more cells of the base station comprise a single cell of the cells of the base station; and
detecting the one or more cells for the base station have entered an operationally active state further comprises detecting a restart message from the single cell.

12. The method of claim 8, wherein each of the one or more tracking areas corresponds to a unique tracking area code.

13. The method of claim 8, wherein sending further comprises sending a write replace warning request message to the base station, wherein the write replace warning request message comprises an indication of one or more tracking area codes to which the one or more cells correspond.

14. A program product comprising a computer-readable storage medium comprising computer-readable code, the computer-readable code when loaded into one or more memories and executed by one or more processors causes an apparatus to perform the method of claim 8.

15. An apparatus, comprising:
one or more processors; and
one or more memories including computer program code,
the one or more memories and the computer program code configured, with the one or more processors, to cause the apparatus to perform at least the following:
storing at a base station alert broadcast information corresponding to a warning message for a public warning system;
detecting that one of a plurality of cells for the base station has entered an operationally active state; and
sending, responsive to the detecting, the warning message to the user equipment for at least the cell that has entered the operationally active state.

16. The apparatus of claim 15, wherein:
the one or more memories and the computer program code are further configured, with the one or more processors, to cause the apparatus to perform at least: determining, using the stored alert broadcast information, whether the cell that has entered the operationally active state is to be sent the warning message; and
sending further comprises sending, in response to a determination the cell that has entered the operationally active state is to be sent the warning message, the warning message to the user equipment for at least the cell that has entered the operationally active state.

17. The apparatus of claim 16, wherein determining, using the stored alert broadcast information, whether the cell that has entered the operationally active state is to be sent the warning message further comprises comparing a cell identification of the cell that has entered the operationally active state with tracking area code information in the stored alert broadcast information and determining that the cell that has entered the operationally active state is to be sent the warning message in response to the cell identification matching a stored cell identification corresponding to the tracking area code information.

18. The apparatus of claim 15, wherein:
the one or more memories and the computer program code are further configured, with the one or more processors, to cause the apparatus to perform at least: determining, using the stored alert broadcast information, whether the cell that has entered the operationally active state was previously sent the warning message; and
sending further comprises sending, in response to a determination the cell that has entered the operationally active state was not previously sent the warning message, the warning message to the user equipment for at least the cell that has entered the operationally active state.

19. The apparatus of claim 15, wherein sending further comprises sending, responsive to the detecting, the warning message to user equipment for all cells, including the cell that has entered the operationally active state, corresponding to a tracking area code that is associated with the warning message and stored in the alert broadcast information.

20. The apparatus of claim 15, wherein the one or more memories and the computer program code are further configured, with the one or more processors, to cause the apparatus to perform at least: sending, responsive to sending the warning message to at least the cell that has entered the operationally active state, a restart message toward a mobility management unit with a flag indicating that an auto-restart occurred at the base station.
